(19) United States
(12) Patent Application Publication
(10) Pub. No.: US 2015/0229243 A1
(43) Pub. Date: Aug. 13, 2015

(54) Device and Method For Tuning Mechanical and Electromagnetic Natural Frequencies of an Energy Harvester

(71) Applicant: Emmanuel F. C. Chimamkpam, Lynnfield, MA (US)

(72) Inventor: Emmanuel F. C. Chimamkpam, Lynnfield, MA (US)

(21) Appl. No.: 14/622,097

(22) Filed: Feb. 13, 2015

Related U.S. Application Data
(63) Continuation-in-part of application No. 14/199,916, filed on Mar. 6, 2014.
(60) Provisional application No. 61/937,330, filed on Feb. 7, 2014.

(51) Int. Cl. H02N 2/18

(52) U.S. Cl. CPC H02N 2/188

(57) ABSTRACT

The present invention is an energy harvester having a mechanical natural frequency that can be mechanically tuned to the natural frequency of the vibrating environment without having to add or subtract mass to seismic/proof mass, change the mass of the mechanical spring or change the physical dimensions of the mechanical spring of the energy harvester. In another embodiment, the electromagnetic natural frequency of the energy harvester is electronically tuned by adding a tuning circuit comprising a variable dissipative element without changing the mechanical natural resonant frequencies of the energy harvester.

### CROSS-REFERENCE TO RELATED APPLICATIONS

This application claims priority to U.S. patent application Ser. No. 14/199,916 filed on Mar. 6, 2014, now pending, which claims priority to U.S. Provisional Application Ser. No. 61/937,330 filed on Feb. 7, 2014, now pending, both of which applications are hereby incorporated into this specification by reference in their entirety.

### BACKGROUND OF THE INVENTION

Most vibration energy harvesters are resonant type and suffer from narrow frequency response, which limits them to operate at a specific frequency that may not match an ambient energy source. The natural frequency of an energy harvester is an intrinsic property of the harvester where absorbed energy is amplified in the form of resonance A composition of at least a moving mass (also called a proof or a seismic mass), m, and a spring, K, together create resonance either as the harvester's own natural frequency or as coupled natural frequency of the vibration source. Natural frequency changes when either mass or stiffness of the device is changed. For energy harvesters to have their absorbed energy amplified at other frequencies, tuning of their natural frequencies has been widely proposed. To the proof mass, an extra mass can be added to change the natural resonant frequency at which energy is harvested. The extra mass added must correspond to the needed mass for attaining the desired new natural resonant frequency. For most devices, addition or subtraction of mass is inconvenient for users as it cannot be done when a conventional energy harvester is factory packaged. However, tuning by mass is the industrial state-of-the-art, as used by Midé Technology Corporation for its piezoelectric cantilever beam based harvesters. Tuning by stiffness at commercial level is uncommon but there were laboratory investigations based on cantilever beams, which are objects of entwined stiffness and mass, such that a physical change in mass of the beam, e.g. coating with thin film, is a change in stiffness due to a change in one or more of the beam's physical dimensions, and vice-versa. Pre-loading, pre-deflection, centrifugal force, magnetic force, gravity center of the tip mass, and actuating piezoelectric transducer are methods that were explored to adjust stiffness of the non-commercial laboratory cantilever beam based harvesters (L. Tang, Y. Yang, C. K. Soh, in Advances in Energy Harvesting Methods, eds. N. Elvin and A. Erturk, Springer Science and Business Media New York 2013). Stiffness change in these methods is predominantly due to a change in Young's modulus as applied stress and beam strain vary. The demonstrated tunability, or, for all the methods is less than 100%, with only ca. 24% of the methods achieving tunability above 50%. An alternative to cantilever beam is mechanical spring that is not entwined with mass, such as helical or plate spring, to which a proof mass is then suspended. In this case, change of stiffness is achieved by changing original physical dimensions (length, width or thickness) of the spring, which could directly mean mechanical extension, contraction, changing of its mass, or use of another mechanical spring that matches the required new resonant frequency. Magnetic and gravitational springs are other kinds of springs that are not naturally entwined with mass, as with the case cantilever beams, and can be used directly for resonant frequency tuning where their stiffness is varied by their variable forces due to varying separations between their sources.

Harvesting electromagnetic energy (electromagnetic radiations at least within radio frequency spectrum (RF) range of <3 Hz (tremendously low frequency, TLF) to 300 GHz (tremendously high frequency, THF)) simultaneously with mechanical or kinetic energy is uncommon. Consequently, the ways to couple and tune resulting resonant frequency due to the synchronized electromagnetic energy harvesting are not known. RF electromagnetic radiations have both an electric and a magnetic component, and electromagnetic field is always produced by conductors when they transport electric current and. An energy harvester with its own magnetic field, as the device in the present invention, can couple by mutual attractive/repulsive interaction, or. mutual inductance, to any electromagnetic field in its environment, such as magnetic field of an AC power cord, power transmission lines, unshielded electronic instruments, broadcasting towers, radars, operating machineries, auroras, etc. This coupling between the harvester and electromagnetic source takes place when their magnetic field lines cross into each other, and occurrence of any resonance is a function of the harvester structural arrangements, electromagnetic radiation source, transducer of the harvester, and electrical power delivering circuitry associated with the harvester. As with mechanical tuning of natural resonant frequency by stiffness, tuning of the electromagnetic resonant frequency brings along the benefit of augmenting harvested vibration energy.

### SUMMARY OF THE INVENTION

One object of the present invention is to provide a method for mechanically tuning the natural frequency response of an energy harvesting device to match the frequency of an energy source, for example ambient vibration without addition or subtraction of mass, replacement of mechanical spring or change in physical dimensions of mechanical spring by stretching (e.g. length), contraction (e.g. length) and coating (e.g. thickness).

Another object of the present invention was to develop a method for electronically tuning coupled electromagnetic natural resonant frequency of an energy harvester without changing the mechanical resonant frequency of the energy harvester.

The present invention is a device and method for harvesting energy from a vibrating environment having a natural frequency. In one embodiment, the device comprises a first housing, left and right sidewalls engaged with the first housing by first and second fasteners, a mechanical spring engaged with the left and right sidewalls; a first magnet engaged with the mechanical spring; and a composite structure comprising a fixed magnet and a piezoelectric material. The first magnet and the fixed magnet apply a force upon the piezoelectric material when the mechanical spring is in a static state to produce a base voltage. Adjustment of the first fastener to a first position and excitation of the mechanical spring by the vibrating environment causes the piezoelectric material to generate a first alternating voltage output comprising a first peak voltage at a first frequency greater than the base voltage. The first frequency is different from the natural frequency of the vibrating environment. Adjustment of the first fastener to a second position and excitation of the mechanical spring by the vibrating environment causes the piezoelectric material to generate a second alternating voltage output comprising a second peak voltage at a second frequency greater than the base voltage. The second frequency being closer to the natural frequency of the vibrational environment than the first frequency. The energy harvester allows a person to tune the mechanical natural frequency by tightening or loosening of the first fastener without any need for adding/subtraction of mass or changing the physical dimensions of the mechanical spring. The energy harvester may further comprise an electromagnetic resonant frequency tuning circuit connected with the piezoelectric material. The electromagnetic resonant frequency tuning circuit comprises a variable dissipative element, which can be in the form of a variable electronic resistor. The electromagnetic resonant frequency tuning circuit allows electronic tuning of the electromagnetic resonant frequency of the energy harvester without changing the mechanical resonant natural frequencies of the energy harvester.

### BRIEF DESCRIPTION OF THE DRAWINGS

The following description of the invention will be further understood with reference to the accompanying drawings, in which:

FIG. 1 is a perspective view of an energy harvesting device according to the present invention;

FIG. 2 is an exploded view of the device;

FIG. 3 is a cross section view of the device taken along line 3-3 of FIG. 2;

FIG. 4 is a top view of a first housing according to the present invention;

FIG. 5 is a left side view of the first housing;

FIG. 6 is a right side view of the first housing;

FIG. 7 is a top view of a second housing according to the present invention;

FIG. 8 is a left side view of the second housing;

FIG. 9 is a right side view of the second housing;

FIG. 10 is a top view of a left sidewall according to the present invention;

FIG. 11 is a side view of the left sidewall housing;

FIG. 12 is a top view of a right sidewall according to the present invention;

FIG. 13 is a side view of the right sidewall housing;

FIG. 14 is a perspective view of a grid according to the present invention;

FIG. 15 is a top view of the grid;

FIG. 16 is a cross-section view of the grid taken along line 16-16 of FIG. 15;

FIG. 17 is a top view of a composite structure according to the present invention having a magnet attached to a piezoelectric material;

FIG. 18 is a front view of the composite structure;

FIG. 19 is a top view of a grid according to the present invention having nine (9) cavities and a composite structure disposed in each cavity of the grid;

FIG. 20 is a cross section view taken along line 19-19 of FIG. 19;

FIG. 21 is a perspective view of a first mechanical spring according to the present invention;

FIG. 22 is a top view of the first mechanical spring;

FIG. 23 is a side view of the first mechanical spring;

FIG. 24 is a perspective view of an assembly of the first mechanical spring and a first magnet according to the present invention;

FIG. 25 is a perspective view of an assembly of the first mechanical spring and first and second magnets according to the present invention;

FIG. 26 is a cross section view of the device showing static magnetic energy available for electromagnetic transduction;

FIG. 27 is an example of real-time data from a data logger demonstrating the harvesting of energy by the device within bandwidth of 50 Hz across a frequency range up to 50 Hz from a random noise base input from a vibration shaker and the linear behavior of the device at such frequencies;

FIG. 28 is an enlarged view of the wave form of FIG. 27 demonstrating harvesting of energy by the device within wider bandwidths at frequencies above 50 Hz and the non-linear behavior of the device at such frequencies;

FIG. 29 is a perspective view of the device having a one-piece housing;

FIG. 30 is a perspective view of the device having a two-piece housing;

FIG. 31 is an exploded view of the device having a two-piece housing;

FIG. 32 is a perspective exploded view of a conductor panel assembly according to the present invention removably mounted to an open side of the device for harvesting energy from electromagnetic transduction to provide a second and independent source of harnessed energy;

FIG. 33 is a front view of the conductor panel assembly;

FIG. 34 is a rear view of the conductor panel assembly,

FIG. 35 is a front view of a frame of the conductor panel assembly,

FIG. 36 is a side view of the frame;

FIG. 37 is a rear view of the frame;

FIG. 38 is a cross section view of the frame taken along line 38-38 of FIG. 35;

FIG. 39 is a cross-section view of the frame taken along line 39-39 of FIG. 35;

FIG. 40 is a perspective view of the energy harvester device as shown in FIG. 1 with one or more screws that allow tuning of the mechanical resonant frequency of the energy harvester device by tightening or loosening of the screw(s);

FIG. 41 is a frequency response data plot showing adjustment or tuning of the mechanical resonant frequency of the energy harvester device after tightening or loosening of one screw;

FIG. 42 is a block diagram showing an energy harvester device connected to a charge to voltage converter by an electromagnetic resonant frequency tuning circuit;

FIG. 43 is a block diagram showing the electromagnetic resonant frequency tuning circuit comprising a variable dissipative resistor;

FIG. 44 is a frequency response data plot showing adjustment or tuning of the electromagnetic (EM) resonant frequency of the energy harvester device using the electromagnetic resonant frequency tuning circuit in the form of a variable resistor; and

FIG. 45 is a frequency response data plot showing adjustment or tuning of the electromagnetic (EM) resonant frequency of the energy harvester device using the electromagnetic resonant frequency tuning circuit in the form of a variable resistor.

### DESCRIPTION OF THE INVENTION

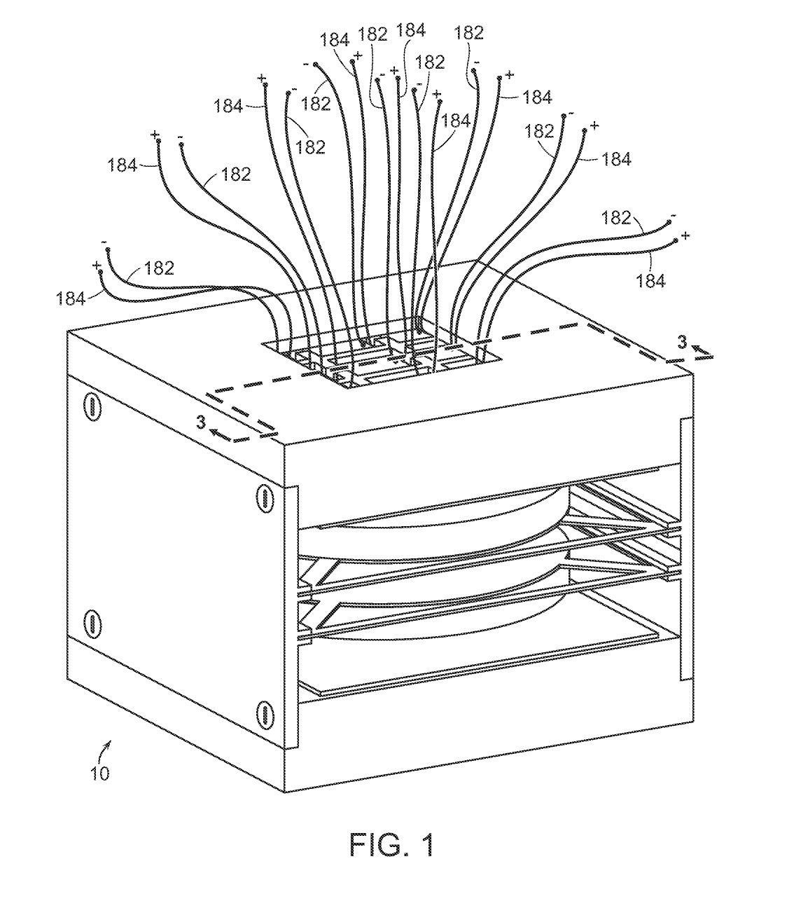

Referring to FIG. 1, where an energy harvesting device 10 according to the present invention is shown. Device 10 collects energy from movements, noise, sound, and stray electromagnetic signals and generates electricity. Movements can be generated from many sources such as transportation systems (for example, cars, trains, bicycles, and airplanes); infrastructures (for example, buildings, bridges, tunnels, and airports); anatomical (for example, human, animals, and plants); and machinery (for example, industrial plants, vacuum pumps, milling machines, and heavy duty vehicles). Noises can be of thermal, electromagnetic perturbations, colored noise, and white noise. Device 10 captures energy sources in the form of sinusoid, random noise, impulse and their different combinations. In the embodiment shown, device 10 has an overall length of 31 mm, a width of 24 mm, and a height of 24 mm. Unlike conventional energy harvesting devices, device 10 captures energy from movements, noise, sound, and stray electromagnetic signals and generates an alternating voltage output having wide bandwidths across an extended range of frequencies allowing more usable and flexible energy extraction in many different types of environments and/or applications.

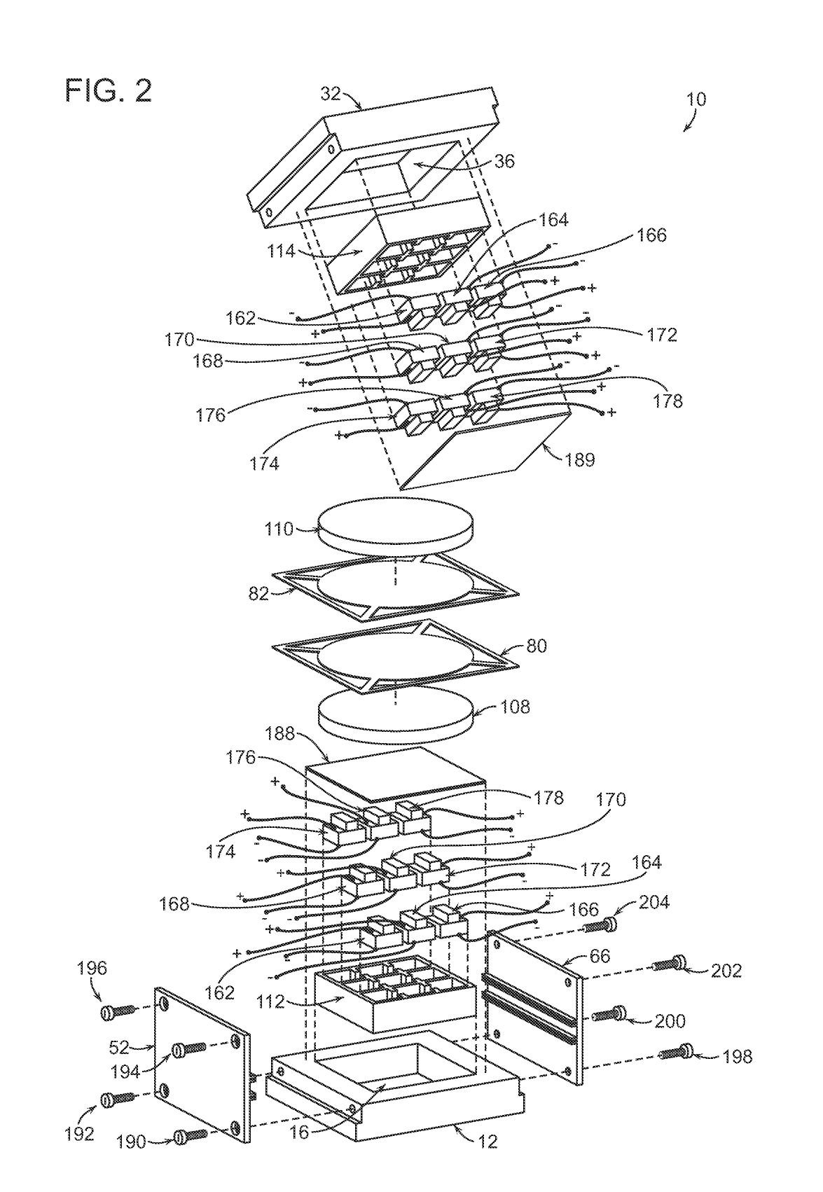

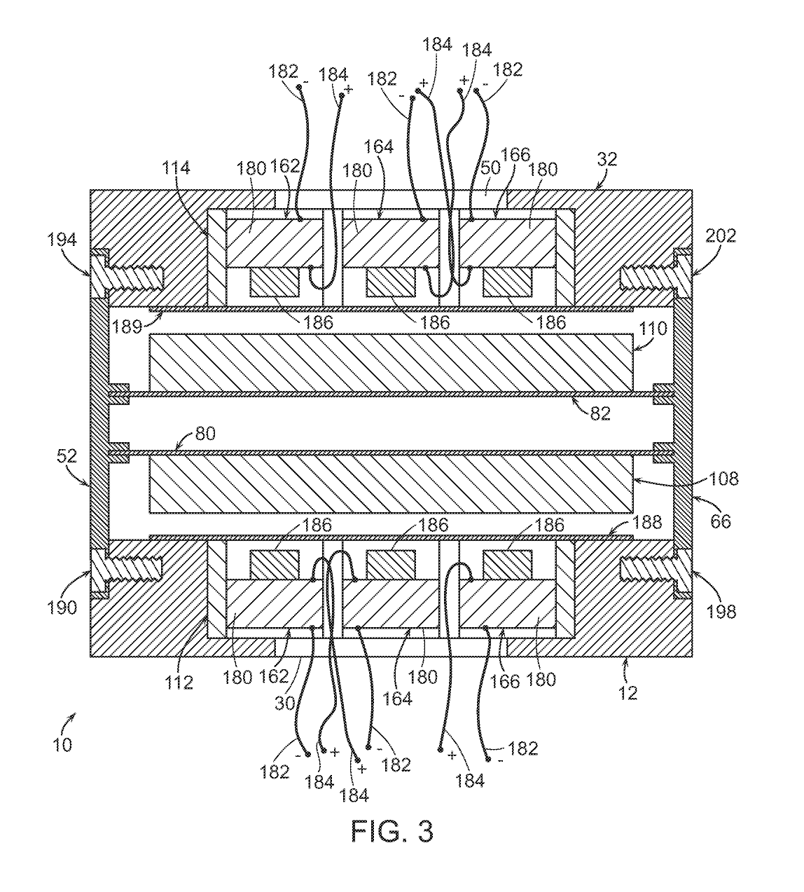

Referring to FIGS. 2 and 3, device 10 generally comprises a first housing 12, a second housing 32, and a left side wall 52 engaged with first and second housings 12 and 32 by fasteners such as bolts 190, 192, 194, and 196, and a right side wall 66 engaged with first and second housings 12 and 32 by fasteners such as bolts 198, 200, 202, and 204. Device 10 further comprises a first mechanical spring 80 engaged with left and right sidewalls 52 and 66. Device 10 further comprises a second mechanical spring 82 engaged with left and right sidewalls 52 and 66. Device 10 further comprises a first magnet 108 engaged with first mechanical spring 80 and a second magnet 110 engaged with second mechanical spring 82. Device 10 further comprises first and second grids 112 and 114 freely engaged with first and second housings 12 and 32, respectively. Device 10 further comprises composite structures 162, 164, 166, 168, 170, 172, 174, 176, and 178 securely disposed within cavities (to be described) of first and/or second grids 112 and 114. Device 10 further comprises one or more pieces of a non-conductive tape 188 applied to and substantially covering the entire inner face of first housing 12 so that first grid 112 may freely move within a cavity 16 (to be described) of first housing 12. Similarly, device 10 further comprises a second piece of non-conductive tape 189 applied to and substantially covering the inner face of second housing 32 so that second grid 114 may freely move within a cavity 36 (to be described) of second housing 32. Wires 182 and 184 of composite structures 162, 164, 166, 168, 170, 172, 174, 176, and 178 pass thru openings 30 and 50, of first and second housings 12, and 32, respectively.

In the static state, first magnet 108 and fixed magnets 186 (to be described) of composite structures 162, 164, 166, 168, 170, 172, 174, 176, and 178 embedded within first housing 12 repel each other applying a force upon piezoelectric blocks 180 (to be described) of composite structures 162, 164, 166, 168, 170, 172, 174, 176, and 178, producing an alternating base voltage across wires 182 and 184 of piezoelectric blocks 180. Similarly, second magnet 110 and fixed magnets 186 (to be described) of composite structures 162, 164, 166, 168, 170, 172, 174, 176 embedded with second housing 32 repel each other applying a force upon piezoelectric blocks 180 (to be described) of composite structures 162, 164, 166, 168, 170, 172, 174, 176, and 178, producing an alternating base voltage across wires 182 and 184 of piezoelectric blocks 180. Excitation of first spring 80 causes oscillation of first magnet 108 to and from the fixed magnets of composite structures 162, 164, 166, 168, 170, 172, 174, 176, and 178 embedded within first housing 12 creating an alternating high voltage across wires 182 and 184 of piezoelectric blocks 180 of composite structures 162, 164, 166, 168, 170, 172, 174, 176, and 178 within wide bandwidths. Similarly, excitation of second spring 82 causes oscillation of second magnet 110 to and from the fixed magnets 186 of composite structures 162, 164, 166, 168, 170, 172, 174, 176, and 178 embedded within second housing 32 creating an alternating high voltage across wires 182 and 184 of a piezoelectric blocks 180 of composite structures 162, 164, 166, 168, 170, 172, 174, 176, and 178 within wide bandwidths. Unlike conventional energy harvesting devices, device 10 produces a high output voltage over wide bandwidths thereby making its dramatically easier to extract energy from device 10 using presently and/or future developed conventional circuit designs. Further, unlike conventional energy harvesting devices, within frequencies greater than 50 Hz, device 10 has unexpected results, namely, non-linear characteristics between different configurations of device 10 thereby allowing each configuration to provide a different voltage level and energy to be exacted from device 10.

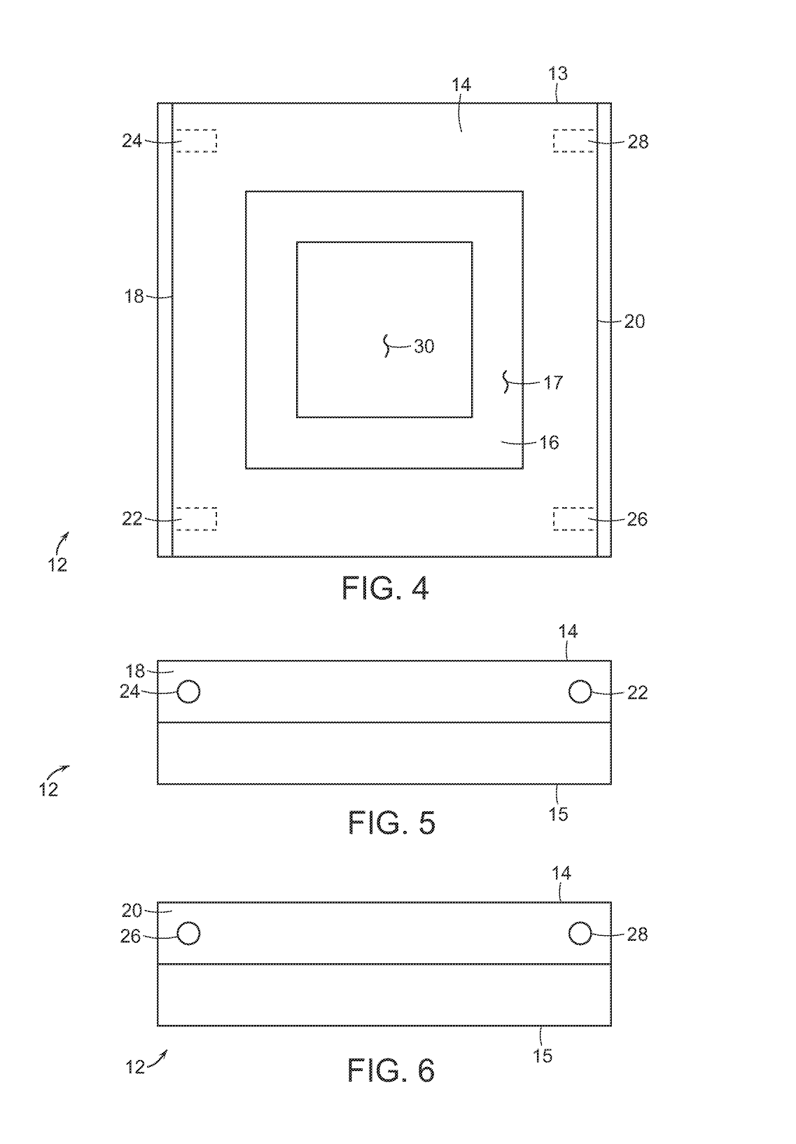

Referring to FIGS. 4-6, first housing 12 comprises a base 13 having inside and outside surfaces 14 and 15, an end portion 18, and an end portion 20. First housing 12 further comprises threaded holes 22 and 24 formed at end portion 18. First housing 12 further comprises threaded holes 26 and 28 formed at end portion 20. First housing 12 further comprises a cavity 16 disposed within base 14 having a floor 17. In the embodiment shown, cavity 16 has a width of 20 mm, a length of 20 mm, and a depth of 5 mm. As will be described more fully herein, first grid 112 can freely move within cavity 16 in all directions to add vibrational energy to device 10 for harvesting. First housing 12 further comprises an opening 30 disposed in floor 17 of cavity 16. As will be described more fully herein, opening 30 is provided so that wires 182 and 184 (to be described) from composite structures 162, 164, 166, 168, 170, 172, 174, 176, and 178 of first grid 112 can pass outside of device 10 for connection to external circuitry to extract the energy from device 10. In the embodiment shown, first housing 12 is made from a highly conductive material such as copper, stainless steel, or graphene. First housing 12 may be fabricated by conventional machining processes.

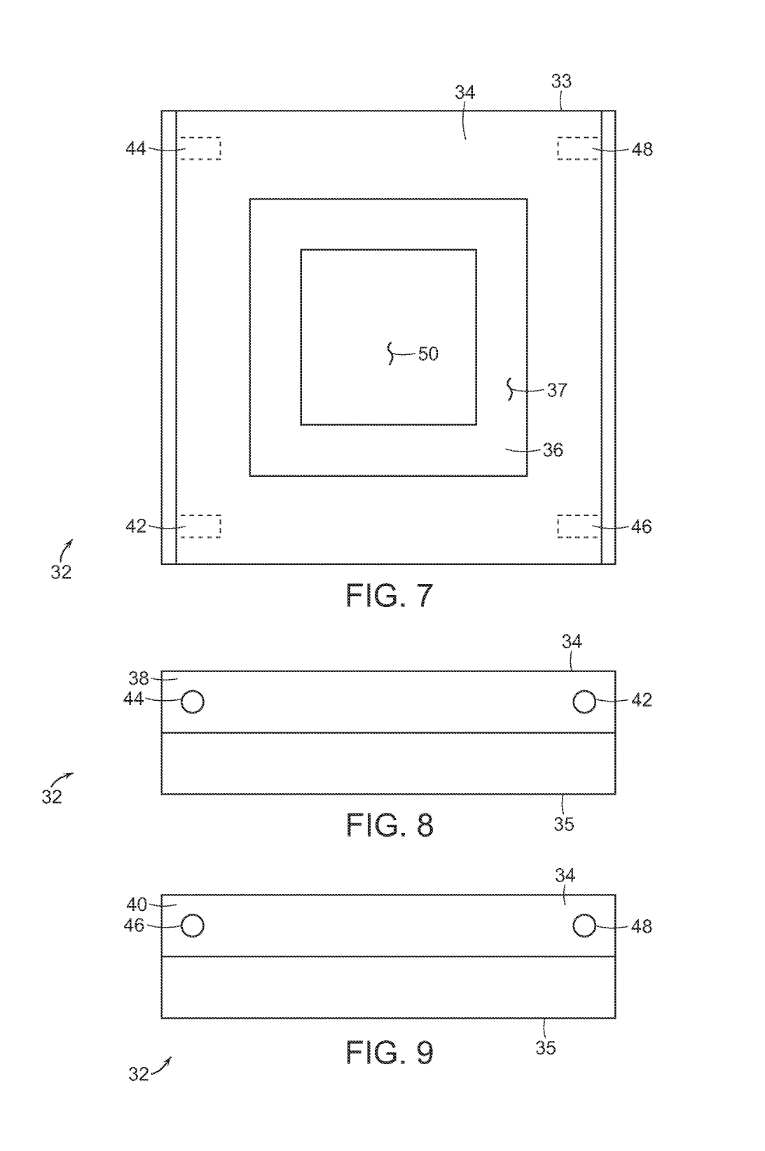

Referring to FIGS. 7-9, second housing 32 is identical to first housing 12. Second housing 32 comprises a base 33 having inside and outside surfaces 34 and 35, an end portion 38, and an end portion 40. Second housing 32 further comprises threaded holes 42 and 44 formed at end portion 38. Second housing 32 further comprises threaded holes 46 and 48 formed at end portion 40. Second housing 32 further comprises a cavity 36 disposed within base 34 having a floor 37. In the embodiment shown, cavity 36 has a width of 20 mm, a length of 20 mm, and a depth of 5 mm. As will be described more fully herein, second grid 114 can freely move within cavity 36 in all directions to add vibrational energy to device 10 for harvesting. Second housing 32 further comprises a central opening 50 disposed in floor 37 of cavity 36. As will be described more fully herein, opening 50 is provided so that wires 182 and 184 from composite structures 162, 164, 166, 168, 170, 172, 174, 176, and 178 of second grid 114 can pass outside of device 10 for connection with external circuitry to extract the energy from device 10. In the embodiment shown, second housing 32 is made from a highly conductive material such as copper, stainless steel, or graphene. Second housing 32 may be fabricated by conventional machining processes.

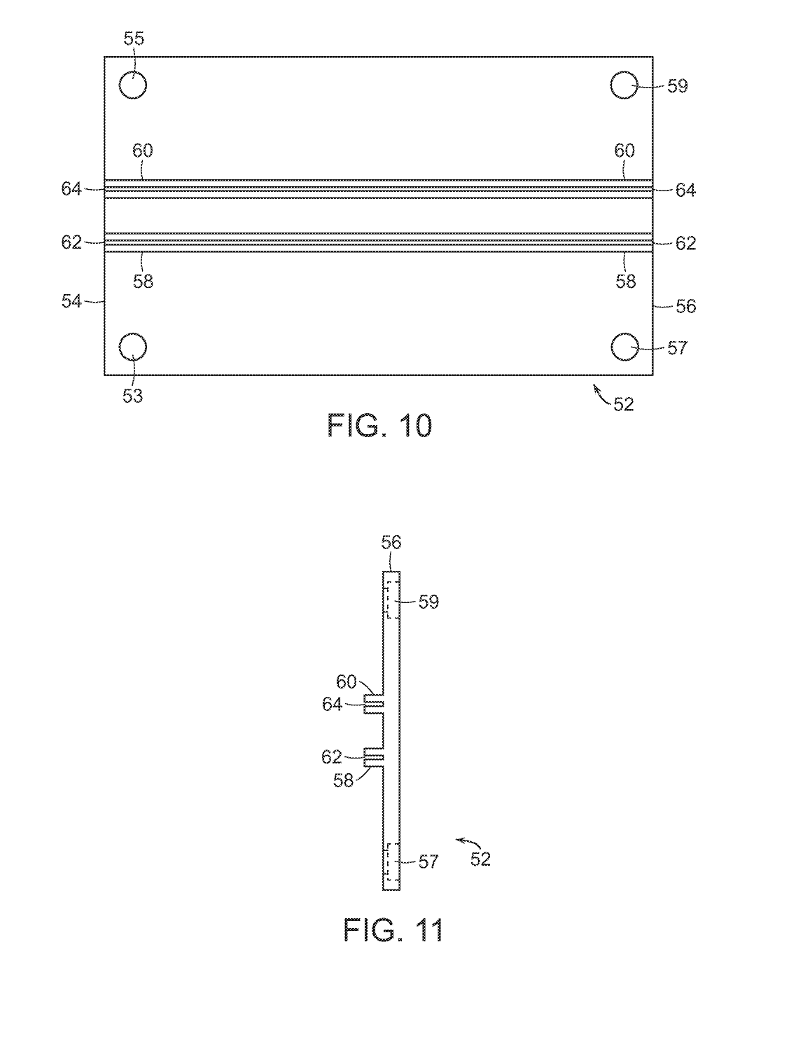

Referring to FIGS. 10-11, left side wall 52 comprises an end portion 54 and an end portion 56. Left side wall 52 further comprises a lower boss 58 extending from end portion 54 to end portion 56. Left side wall 52 further comprises an upper boss 60 extending from end portion 54 to end portion 56. Left side wall 52 further comprises a lower channel or slot 62 formed in lower boss 58 extending from end portion 54 to end portion 56. Left side wall 52 further comprises an upper channel or slot 64 formed in upper boss 60 extending from end portion 54 to end portion 56. As will be described more fully herein, lower slot 62 is adapted to removably engage and receive first mechanical spring 80. Similarly, upper slot 64 is adapted to removably engage and receive second mechanical spring 82. Left side wall 52 further comprises threaded holes 53 and 55 disposed at end portion 54 to receive bolts 190 and 192. Left side wall 52 further threaded holes 57 and 59 disposed at end portion 56 to receive bolts 194 and 196. In the embodiment shown, left side wall 52 has a thickness of 1 mm, lower and upper bosses 58 and 60 have a depth of 1 mm, and lower and upper slots 62 and 64 have a depth of 1 mm. In the embodiment shown, left sidewall 52 is made from a highly conductive material such as copper, stainless steel, or graphene. Left side wall 52 may be fabricated by conventional machining processes.

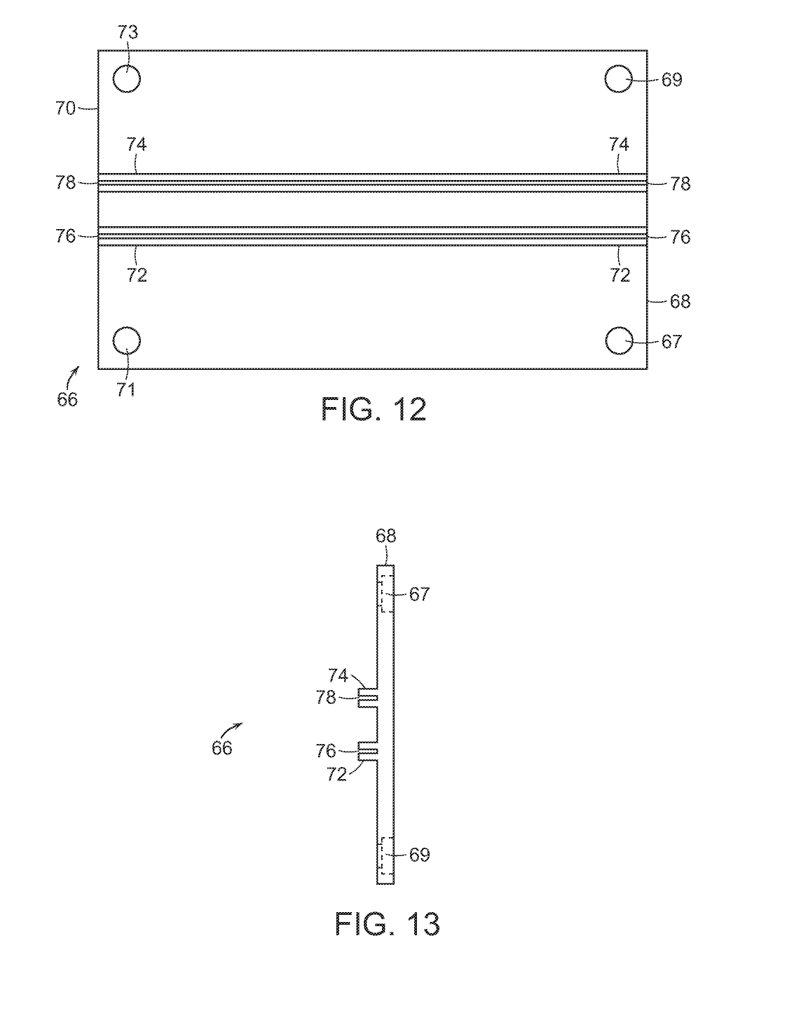

Referring to FIGS. 12-13, right side wall 66 is identical to left side wall 52. Right side wall 66 comprises an end portion 68 and an end portion 70. Right side wall 66 further comprises a lower boss 72 extending from end portion 68 to end portion 70. Right side wall 66 further comprises an upper boss 74 extending from end portion 68 to end portion 70. Right side wall 66 further comprises a lower channel or slot 76 formed in lower boss 72 extending from end portion 68 to end portion 70. Right side wall 66 further comprises an upper channel or slot 78 formed in upper boss 74 extending from end portion 68 to end portion 70. As will be described more fully herein, lower slot 76 is adapted to removably engage and receive first mechanical spring 80. Similarly, upper slot 78 is adapted to removably engage and receive second mechanical spring 82. Right side wall 66 further comprises threaded holes 67 and 69 disposed at end portion 68 to receive bolts 198 and 200. Right side wall 66 further comprises threaded holes 71 and 73 disposed at end portion 70 to receive bolts 202 and 204. In the embodiment shown, right side wall 66 has a thickness of 1 mm, lower and upper bosses 72 and 74 have a depth of 1 mm, and lower and upper slots 76 and 78 have a depth of 1 mm. In the embodiment shown, right side wall 56 is made from a highly conductive material such as copper, stainless steel, or graphene. Right side wall 66 may be fabricated by conventional machining processes.

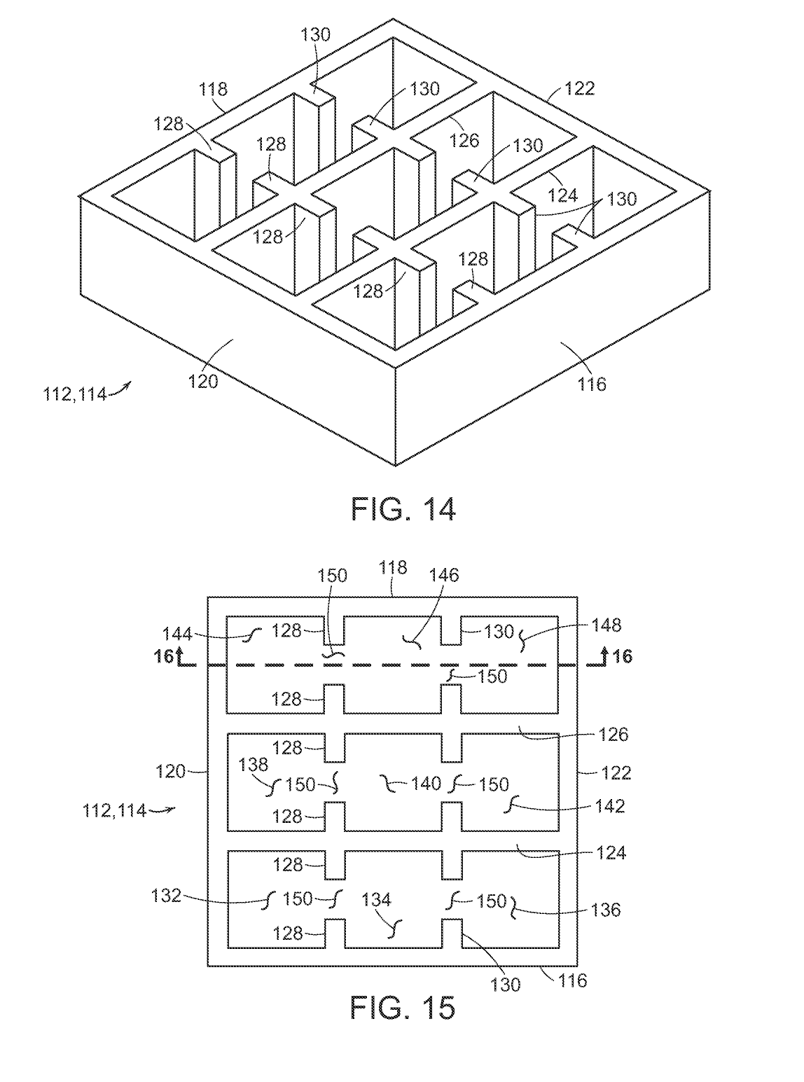

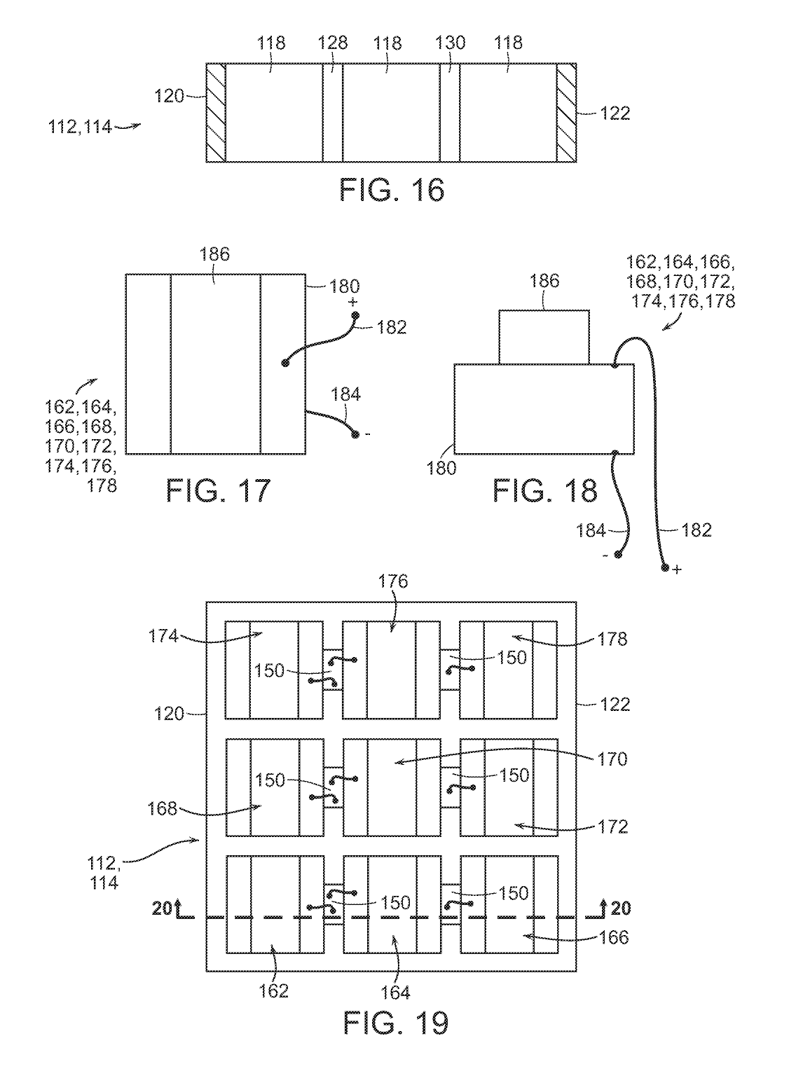

Referring to FIGS. 14-16, first grid 112 is identical to second grid 114. Each of grids 112 and 114 comprise a front wall 116, a rear wall 118, a left sidewall 120, and a right sidewall 122. Each of grids 112 and 114 further comprise an internal wall 124, an internal wall 126, and internal walls 128 and 130 that form nine (9) hollow cavities, namely, a cavity 132, cavity 134, cavity 136, cavity 138, cavity 140, cavity 142, cavity 144, cavity 146, and a cavity 148. Each of grids 112 and 114 further comprise a channel 150 formed in each of internal walls 128 and 130 forming cavity 132, 134, 136, 140, 142, 144, 146, and 148. Channels 150 of grid 112 are provided so that wires 182 and 184 (to be described) from piezoelectric block 180 (to be described) of composite structures 162, 164, 166, 168, 170, 172, 174, 176, and 178 may pass thru channels 150 of first grid 112 and out of first housing 12 for connection with external circuitry. Similarly, channels 150 of grid 114 are provided so that wires 182 and 184 (to be described) from composite structures 162, 164, 166, 168, 170, 172, 174, 176, and 178 may pass thru channel 150 of grid 114 and out of second housing 32 for connection with external circuitry. Each of grids 112 and 114 have a length of 19 mm, a width of 19 mm, and a height of 5 mm. As such, grids 112 and 114 may freely move within cavity 16 and cavity 36, respectively, by an amount equal to 1 mm. Free movement of grids 112 and 114 within cavity 16 and 36, respectively, provides an additional degrees of freedom and thus an additional mechanism to capture vibrational energy. Front wall 116, rear wall 118, left sidewall 120, and right sidewall 122 each have a thickness of 1 mm and a length of 19 mm. Internal wall 124 and internal wall 126 each have a thickness of 1 mm and extend from front wall 116 to rear wall 118. Internal wall 128 and internal wall 130 each have a thickness of 1 mm and extend from left sidewall 120 to right sidewall 122. Cavity 132, cavity 134, cavity 136, cavity 138, cavity 140, cavity 142, cavity 144, cavity 146, and cavity 148 each have a width of 5 mm, a length of 5 mm, and a height of 5 mm. In the embodiment shown, each of grids 112 and 114 is made from a highly conductive material such as copper, stainless steel, or graphene. Each of first and second grids 112 and 114 may be fabricated by conventional machining processes.

Referring to FIGS. 17-18, each of composite structures 162, 164, 166, 168, 170, 172, 174, 176, and 178 are identical to each other. For ease of description, only composite structure 162 will be described. Composite structure 162 comprises a piezoelectric block 180 having a first wire 182 extending from and electrically connected to its positive face and a second wire 184 extending from and electrically connected to its negative face. Composite structure 162 further comprises a magnet 186 securely attached to the upper surface of piezoelectric block 180 by conventional means such as adhesive. Magnet 186 is centrally disposed upon and extend the entire length of piezoelectric block 180. In the embodiment shown, piezoelectric block 180 is made from a Navy Type I (PZT-4) piezoelectric material available from APC International, Ltd., P.O. Box 180, Makeyville, Pa. 17750 USA via its online store (www.americanpiezo.com) in any desired dimension. In the embodiment shown, piezoelectric block 180 has a length of 5 mm, a width of 5 mm, and a thickness of 2.0 mm. In the embodiment shown, magnet 186 is rectangular shaped 45H Neodymium magnet having a length of 5 mm, a width of 2.5 mm, a thickness of 1.5 mm, and a performance rating of 0.35 kg Pull Force and 2900 Gauss. Magnet 186 is available as Product No. MOD2-20 from MAGNET Expert Ltd., Walker Industrial Estate, Ollerton Road, Tuxford, Nottinghamshire, NG22 0PQ United Kingdom via its online store (www.first4magnet.com).

Referring to FIGS. 19-20, where composite structures 162, 164, 166, 168, 170, 172, 174, 176, and 178 are shown securely disposed within cavity 132, 134, 136, 138, 140, 142, 144, 146, and 148 of first grid 112, respectively. This would be the same view as the assembly of second grid 114 with composite structures 162, 164, 166, 168, 170, 172, 174, 176, and 178. As best shown by FIG. 20, wire 184 from piezoelectric block 180 of composite structure 162 passes from cavity 132 of first grid 112 thru opening 30 of first housing 12. Wire 182 from piezoelectric block 180 of composite structure 164 passes from cavity 132 thru channel 150 and outward of opening 30 of first housing 12. Similarly, wire 184 from piezoelectric block 180 of composite structure 164 passes from cavity 134 of first grid 12 thru opening 30 of first housing 12. Wire 182 from piezoelectric block 180 of composite structure 164 passes from cavity 134 of first grid 112 thru channel 150 and opening 30 of first housing 12. Similarly, wire 184 from piezoelectric block 180 of composite structure 166 passes from cavity 136 of first grid 112 thru opening 30 of first housing 12. Wire 182 from piezoelectric block 180 of composite structure 166 passes from cavity 136 of first grid 12 thru channel 150 and opening 30 of first housing 12. This cross-section view of the assembled first grid 12 is identical to assembled second grid 114 with composite structures 162, 164 and 166 securely disposed within cavity 132, cavity 134, cavity 136 of second grid 114, respectively.

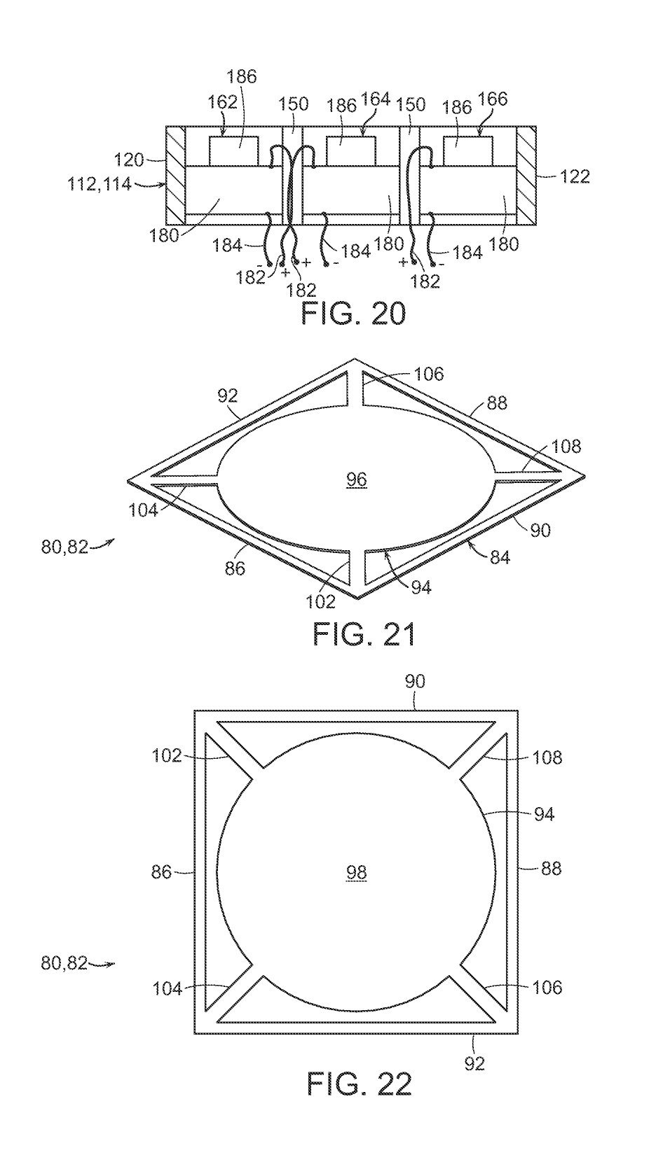

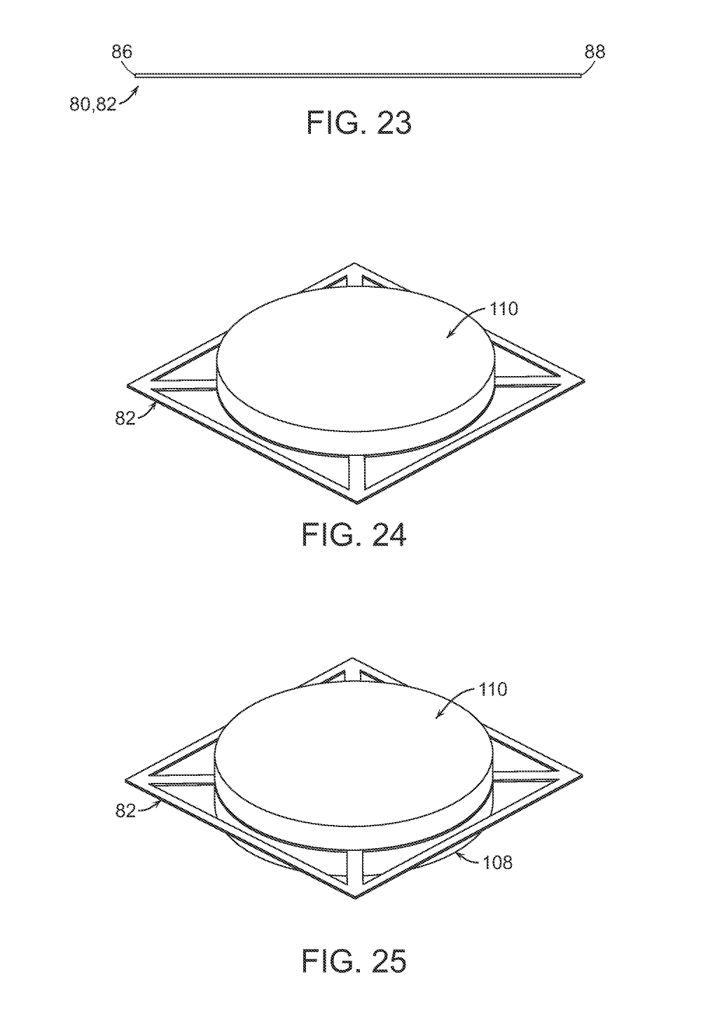

Referring to FIGS. 21-23, first and second mechanical springs 80 and 82 each comprise an outer body 84 having a left side portion 86, a right side portion 88, a front side portion 90, and a rear side portion 92. Each of first and second mechanical springs 80 and 82 further comprise an inner body 94 having a top surface 96 and a bottom surface 98. Inner body 94 is attached to outer body 84 by anchors 100, 102, 104, and 106. Left side portion 86 and right side portion 88 of first mechanical spring 80 removably slide within lower slot 62 of left side wall 52 and lower slot 76 of right side wall 66, respectively. Left side portion 86 and right side portion 88 of second mechanical spring 82 removably slide within upper slot 64 of left side wall 52 and upper slot 78 of right side wall 66. In the embodiment shown, inner and outer body 84 and 94, and anchors 100, 102, 104, and 106, of first and second mechanical springs 80 and 82 are made from a single piece of widely available stainless steel shim stock having a thickness of 0.20 mm. Each of anchors 100, 102, 104 and 106 have a width of 1 mm. The thickness of inner and outer body 84 and 94 and the thickness and/or width of anchors 100, 102, 104, and 106 may be varied to adjust the resonant frequency of first and/or second mechanical springs 80 and 82. Each of first and second mechanical springs 80 and 82 may be fabricated by conventional machining processes.

Referring to FIG. 24, where second magnet 110 is shown removably attached to second mechanical spring 82 by conventional means such as adhesive. In the embodiment shown, first magnet 108 is identical to second magnet 110 and is secured to first mechanical spring 80 in the same manner. Each of magnets 108 and 110 are circular shaped N42 Neodymium magnet having a diameter of 25 mm, a thickness of 3 mm, and a performance rating of 5.1 kg Pull Force and 1600 Gauss. Magnets 108 and 110 are available as Product No. F253-2 from MAGNET Expert Ltd., Walker Industrial Estate, Ollerton Road, Tuxford, Nottinghamshire, NG22 0PQ United Kingdom via its online store (www.first4magnet.com.). In the embodiment shown, first magnet 108, at a static state, is spaced a distance of 1 mm from first grid 112. Similarly, second magnet 110, at a static state, is spaced a distance of 1 mm from second grid 114.

Device 10 may be assembled in different configurations depending upon the desired energy output. In a maximum power configuration, composite structures 162, 166, 168, 170, 172, 174, 176, and 178 are secured in first grid 112. Second, composite structures 162, 166, 168, 170, 172, 174, 176, and 178 are secured in second grid 114. Third, first grid 112 is freely disposed in cavity 16 of first housing 12. Fourth, second grid 114 is freely disposed in cavity 36 of second housing 32. Fifth, tape 188 is placed over first grid 112 and inside surface 14 of first housing 12 thereby preventing first grid 112 from falling out of cavity 16 of first housing 12 and composite structures 162, 166, 168, 170, 172, 174, 176, and 178 from falling out of first grid 112, thereby allowing movement of first grid 112 in all directions within cavity 16 of first housing 12. Sixth, tape 188 is placed over second grid 114 and inside surface 34 of second housing 32 thereby preventing second grid 114 from falling out of cavity 36 of second housing 32 and composite structures 162, 166, 168, 170, 172, 174, 176, and 178 from falling out of second grid 114 thereby allowing movement of second grid 114 in all directions within cavity 36 of first housing 12. Seventh, left side wall 52 is secured to end portion 18 of first housing 12 by bolts 190 and 192. Eighth, right side wall 66 is secured to end portion 20 of first housing 12 by bolts 198 and 200. Ninth, left side wall 52 is secured to end portion 38 of second housing 32 by bolts 194 and 196. Tenth, right side wall 66 is secured to end portion 40 of second housing 32 by bolts 202, and 204. Eleventh, first magnet 108 is secured to inner body 94 of first mechanical spring 80 and left and right side portions 86 and 88 of first mechanical spring 80 are inserted into lower slots 62 and 76 of left and right side walls 52 and 66, respectively. Thereafter, second magnet 110 is secured to inner body 94 of second mechanical spring 82 and left and right side portions 86 and 88 of second mechanical spring 82 are inserted into upper slots 64 and 78 of left and right side walls 52 and 66, respectively. In a full configuration, device 10 is standing up such that left side wall 52 acts as a mounting surface or free standing base for deployment in various vibrational energy environments such as direct mounting to an industrial machine or a person.

The structure of device 10 uses multiple mechanisms for the production of electricity as a hybrid of both linearity and nonlinearity such that harvested energy can be amplified or attenuated and the frequency at which energy is harvested can be shifted according to the desire of the user. Specifically, device 10 comprises at least three mechanisms for harvesting ambient energy: (1) confluence and synergy of forces wherein there is interplay of gravitational, mechanical, electrostatic and electromagnetic forces to maximize generated power and to widen bandwidth of operation; (2) direct communication between a suspended magnetic body and a composite structure comprising a magnet and a piezoelectric block; and (3) free or regulated motion of a conductor grid holding the composite of the magnet and piezoelectric structures. As will be described more fully herein, device 10 may employ another mechanism, namely, electromagnetic induction associated with a suspended helical wire (to be described).

Referring to FIG. 25, where first and second magnets 108 and 110 are shown attached to bottom and top surfaces 98 and 96, respectively, of second mechanical spring 82. This represents another configuration of device 10 where only one mechanical spring is employed and one or more grids of composite structures. As will be described more fully herein, this double mass configuration of second mechanical spring 82 uncovered a non-linear characteristic response of device 10 above 50 Hz that is not present in conventional devices.

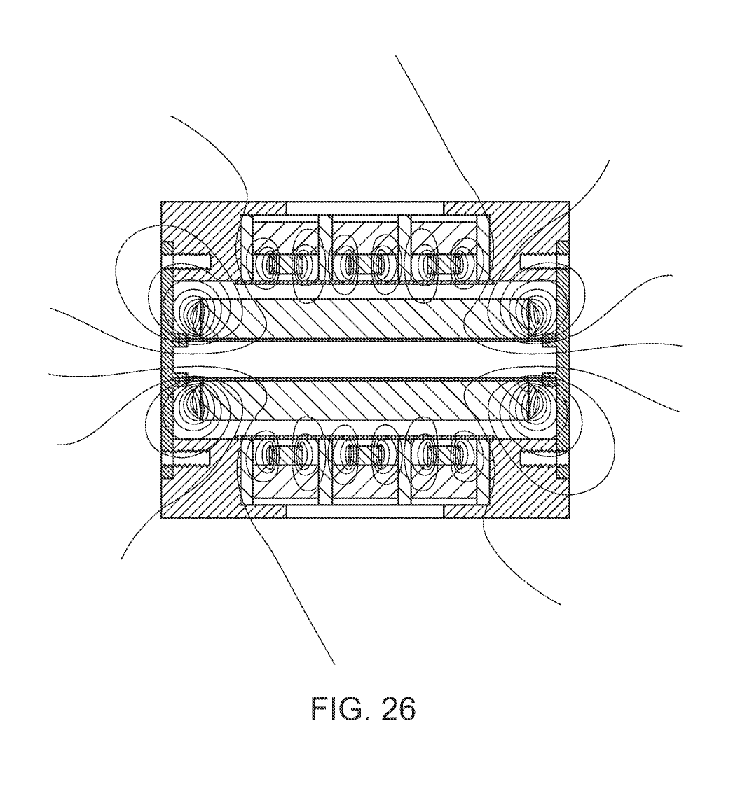

Referring to FIG. 26, where a cross section view of device 10 shows static magnetic energy available for electromagnetic transduction.

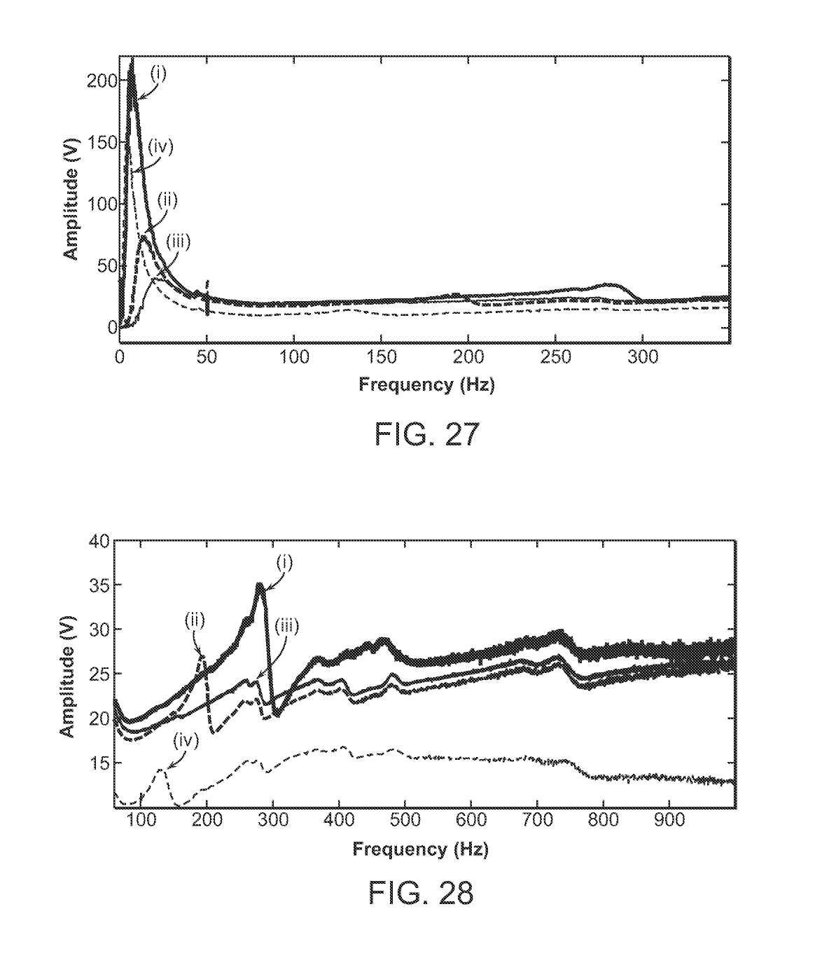

Referring to FIGS. 27-28, four different configurations of device 10 were tested with first housing 12 attached to a shaker table. Electrical outputs from wires 82 and 84 of three composite structures 180 of second housing 32 were connected to a data logger and the results are shown in FIGS. 27 and 28. The four different configurations are labeled and described as follows: (i) the presence of first and second magnets 108 and 110 secured to first and second mechanical springs 80 and 82, respectively; (ii) the presence of only second magnet 110 secured to second mechanical spring 82; (iii) the absence of first and second magnets 108 and 110 and first and second mechanical springs 80 and 82; and (iv) the presence of only first and second magnets 110 secured to second mechanical spring 82. In each of the above configurations, only three out of the eighteen cavities of first and second grids 110 and 112 were populated with the composite structure representing seventeen percent of the total capacity of device 10 in the piezoelectric mode. Unlike conventional energy harvesting devices, the real time data of device 10 demonstrate the harvesting of energy by device 10 in large bandwidths across wide ranges of frequencies, for example, a band width of 50 Hz at a low frequency region (FIG. 27), and significantly larger bandwidths within a frequency range of 50 Hz to 350 Hz, differing in width according to configurations (FIG. 28). Examples are given below in Tables 1 and 2 of performance parameters as extracted from FIGS. 27 and 28 for device 10 at seventeen percent (17%) of its total capacity. Circuitry for extraction of energy from the piezoelectric mode comprises high input impedance and low output impedance. Real power was dissipated across less than ten ohms.

TABLE 1
Frequency below 50 Hz (Linear Character)

| Data Labels | | | |
|---|---|---|---|
| (Configuration) | Peak Frequency (Hz) | Voltage (V) | Bandwidth (Hz) |
| (i) | 7.02 | 217.44 | 50 |
| (ii) | 14.04 | 73.85 | 50 |
| (iii) | 21.97 | 41.15 | 50 |
| (iv) | 4.12 | 157.50 | 50 |

TABLE 2
Frequency above 50 Hz and below 350 Hz (Non-Linear Character)

| Data Labels | | | Bandwidth |
|---|---|---|---|
| (Configuration) | Peak Frequency (Hz) | Voltage (V) | (Hz) |
| (i) | 281.68 | 34.95 | 225 |
| (ii) | 193.18 | 27.02 | 127 |
| (iii) | Not Applicable | Not Applicable | Not Applicable |
| (iv) | 131.07 | 14.31 | 80 |

Unlike conventional devices, within the alternating voltage wave form produced by the device of the present invention are a series of wide bandwidths of over the linear region of the wave form and wider bandwidths of energy available over the non-linear region of the wave form. The availability of energy over both the linear and non-linear portions of the waveform at larger bandwidths makes it possible to extract significantly more useful power than conventional energy harvesters.

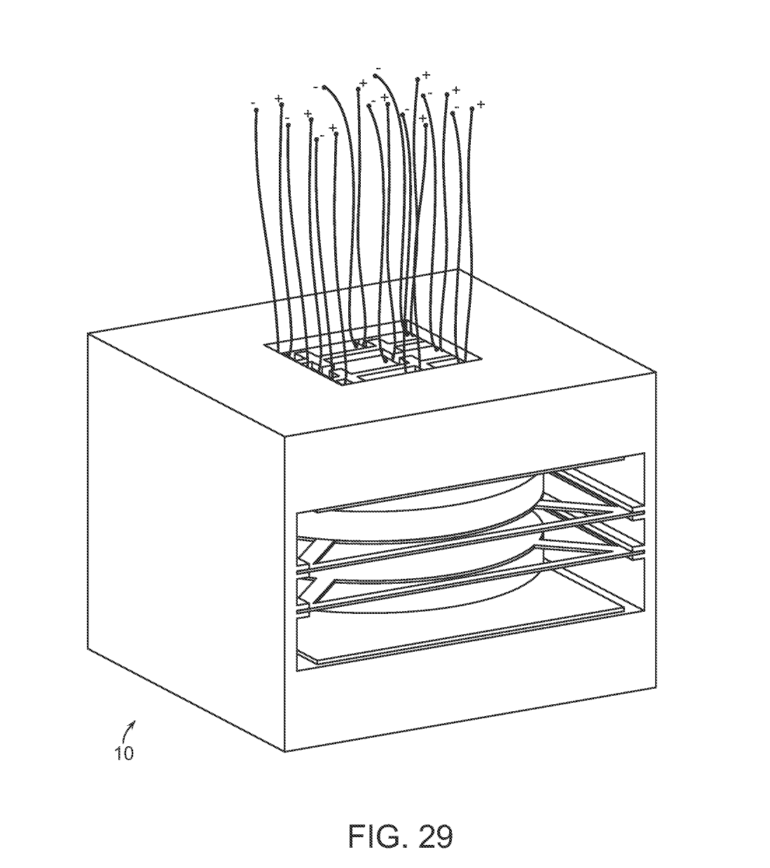

Referring to FIG. 29, where device 10 is shown having a one piece housing. Fabrication of a one piece housing may be accomplished by current three dimensional (3-D) printing processes or other futurely developed technologies.

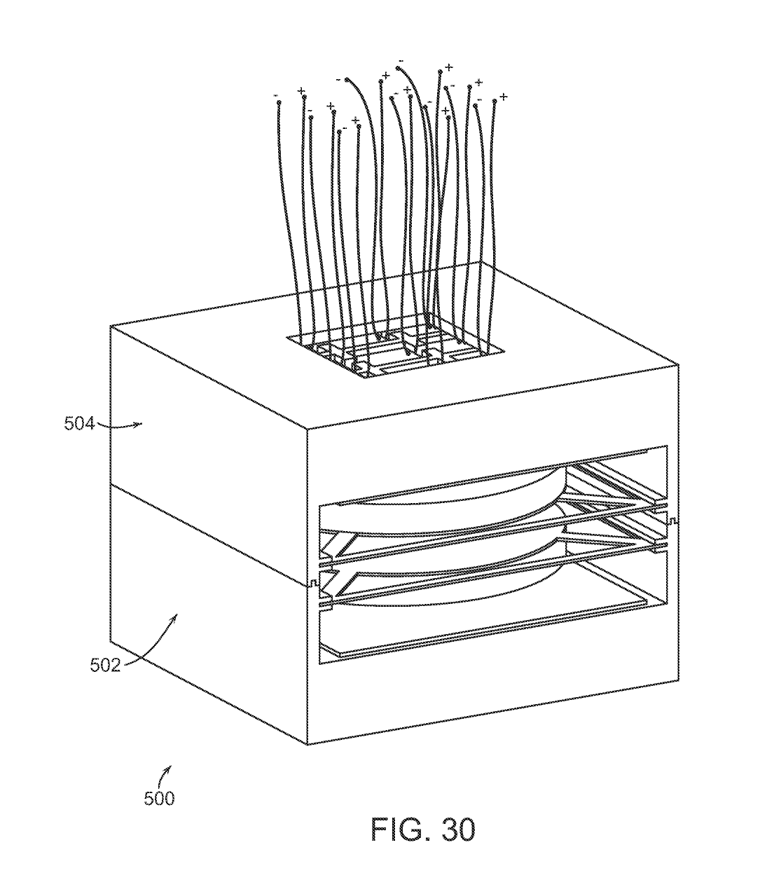

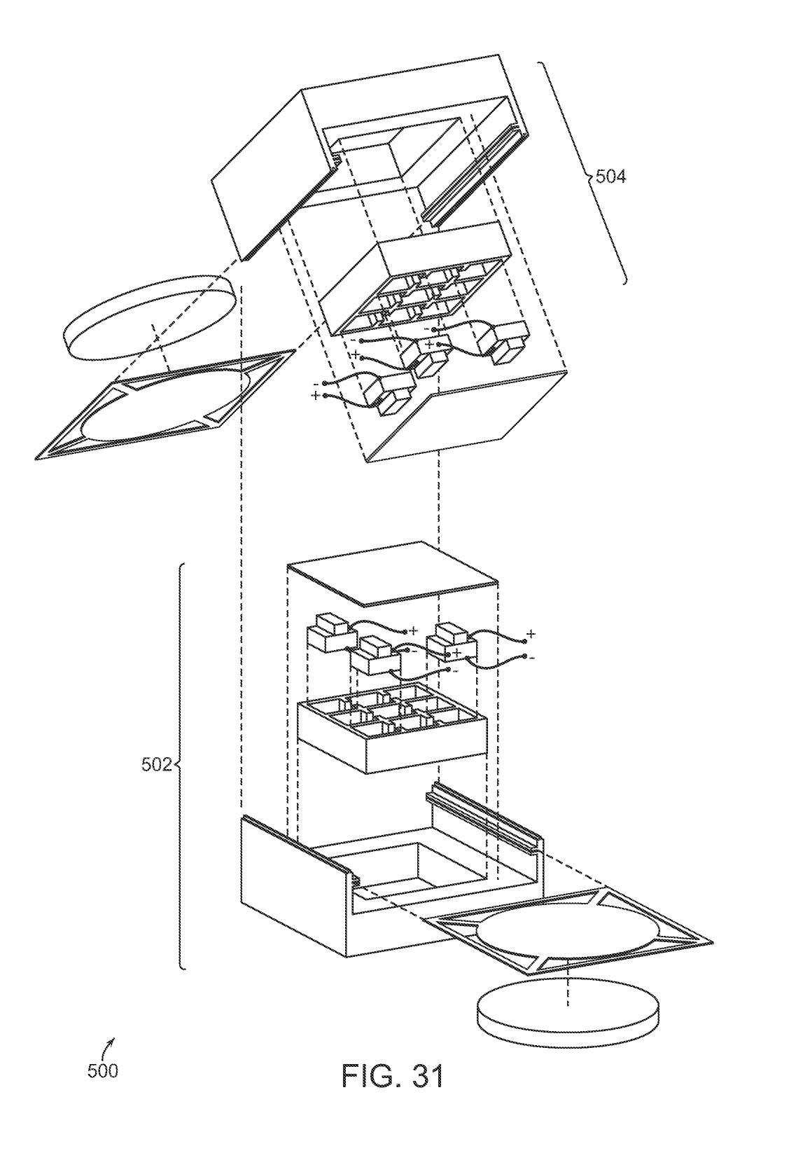

Referring to FIGS. 30 and 31, where device 10 is shown having a two piece housing. A two piece housing allows for each modular use of separate cores or grids to produce energy. Two piece housing may be accomplished by current machining processes or three dimensional (3-D) printing processes or other futurely developed technologies.

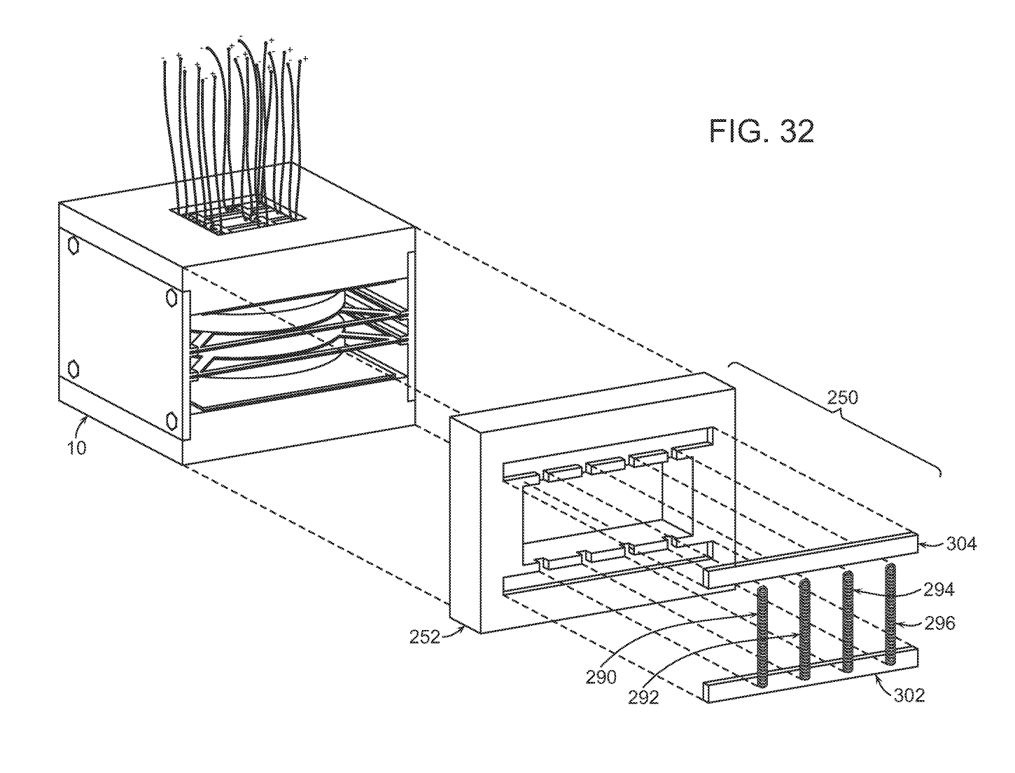

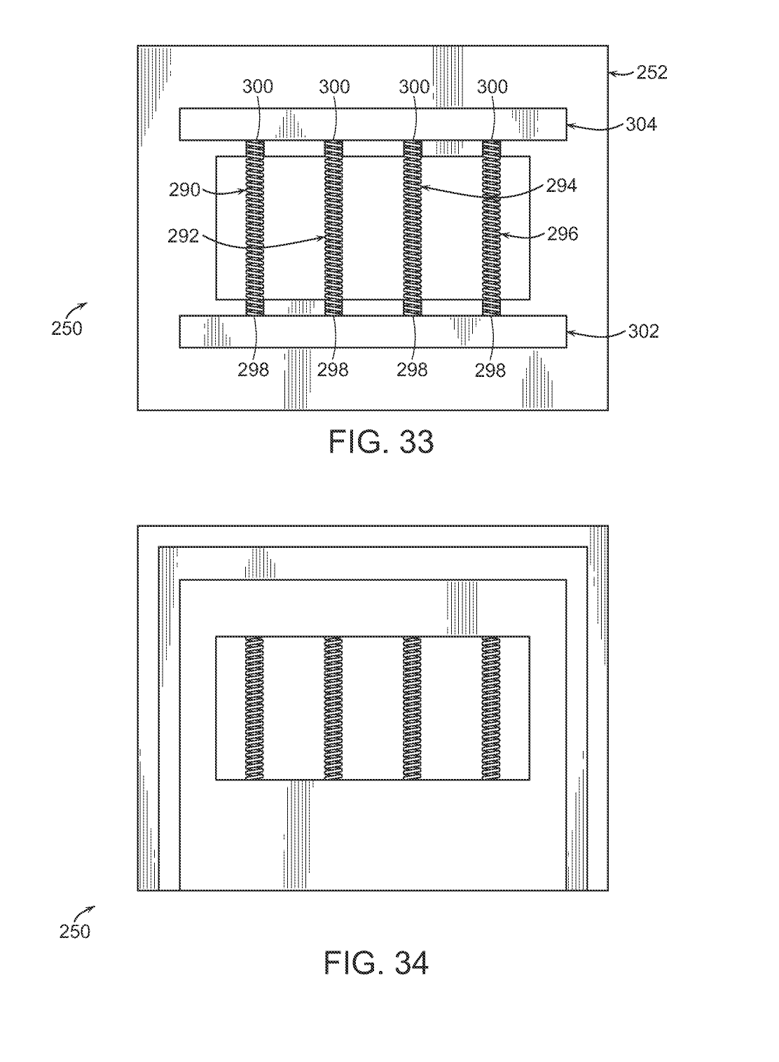

Referring to FIGS. 32-34, where a conductor panel assembly 250 is removably mounted to an open end of device 10 to provide electromagnetic transduction independent of the output from the piezoelectric materials. Conductor panel assembly 250 generally comprises a frame 252, helical wires 290, 292, 294, and 296 freely mounted to frame 252, and first and second conductors 302 and 304 electrically connected with helical wires 290, 292, 294, and 296 to provide a low impedance AC output. Movements of helical wires 290, 292, 294 and/or 296 within the static or changing magnetic fields of first and second magnets 108 and 110 (and the static magnetic field of fixed magnets 186 of composite structures 162, 164, 166, 168, 170, 172, 174, 176 and 178) induces a current into helical wires 290, 292, 294, and 296 that is output across first and second conductors 302 and 304.

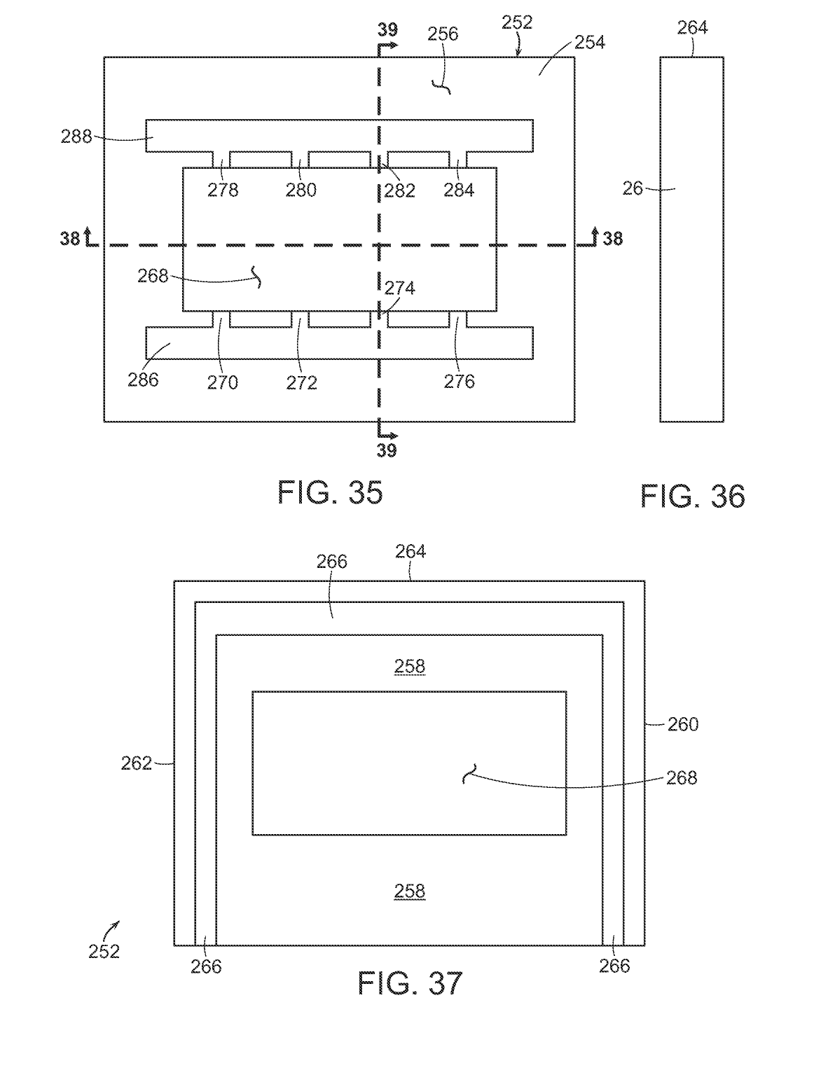

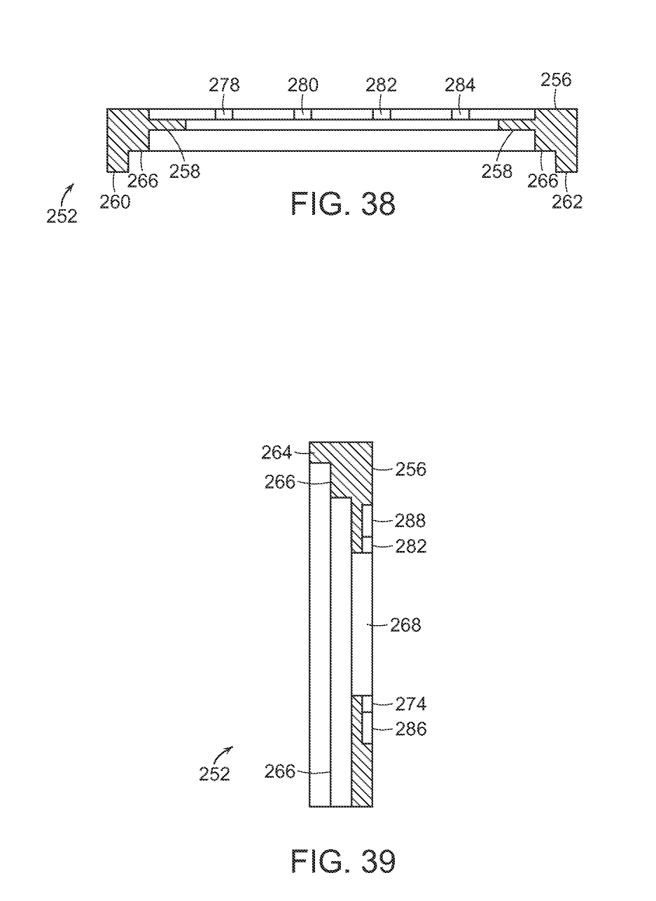

Referring to FIGS. 35-39, frame 252 comprises a wall 254 having an outside surface 256 and an inside surface 258, a left side wall 260, a right side wall 262, and a top side wall 264. Frame 252 further comprises a boss 266 extending upward from inside surface 258 at the innermost end of left sidewall 260, right side wall 262, and top side wall 24. Frame 252 further comprises an opening 269 that in the embodiment is square shaped and sized to match the open face portion of device 10. Frame 252 further comprises a lower coil cavity 270, a lower coil cavity 272, a lower coil cavity 274, and a lower coil cavity 276. Frame 252 further comprises an upper coil cavity 278, upper coil cavity 280, an upper coil cavity 282, and an upper coil cavity 284. Frame 252 further comprises a lower conductor cavity 286 and a upper conductor cavity 288. Conductors 302 and 304 are secured within lower conductor cavity 286 and upper conductor cavity 288, respectively, by conventional means such as adhesive. End portions 298 and 300 of helical wire 290 are secured to lower and upper coil cavity 270 and 278, respectively, by conventional means such as adhesive. End portions 298 and 300 of helical wire 290 are electrically connected to first and second conductors 302 ad 304 by conventional soldering operations. End portions 298 and 300 of helical wire 292 are secured to lower and upper coil cavity 272 and 280, respectively, by conventional means such as adhesive. End portions 298 and 230 of helical wire 292 are electrically connected to first and second conductors 302 ad 304 by conventional soldering operations. End portions 298 and 300 of helical wire 294 are secured to lower and upper coil cavity 274 and 282, respectively, by conventional means such as adhesive. End portions 298 and 300 of helical wire 294 are electrically connected to first and second conductors 302 ad 304 by conventional soldering operations. End portions 298 and 300 of helical wire 296 are secured to lower and upper coil cavity 274 and 284, respectively, by conventional means such as adhesive. End portions 298 and 300 of helical wire 296 are electrically connected to first and second conductors 302 ad 304 by conventional soldering operations. Each of helical wires 290, 292, 294, and 296 may be any type of highly conductive wire or helical coil. For example, each of helical wires 290, 292, 294, and 296 may be copper micro coils having a thickness of 58 gauge and an outside diameter of about 1 mm available from Benatav Ltd., 16 Zvi-Bergman Street, Petach-Tikva, 4927973, Israel (www.benatav.com).

Device 10 may also include additional ways of harvesting energy using a piezoelectric block 180. Specifically, deflection of the two unfixed parts 90 and 92 of first and second mechanical springs 80 and 82, respectively, act as fixed-fixed spring beams upon which one or more piezoelectric blocks 180 may be attached.

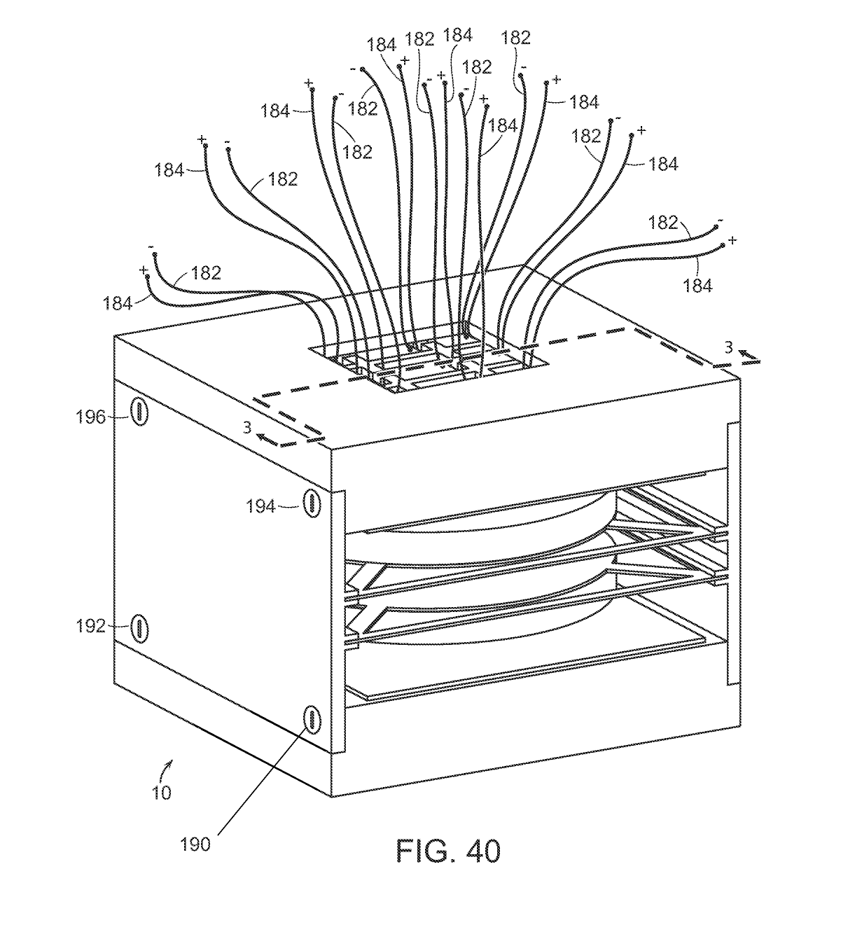

Referring to FIGS. 2 and 40, energy harvester device 10 comprises screws 190, 192, 198, and 200 for fastening left and right sidewalls 52 and 66 to first housing 12 and fasteners 194, 196, 202 and 204 for fastening left and right sidewalls 52 and 66 to second housing 32. Energy harvester device 10 has multiple degrees of freedom, including mechanical spring 80 carrying magnet 108. The mechanical resonant frequency of the mechanical spring 80 of energy harvester device 10 may be adjusted or tuned by tightening or loosening at least one of screws 190, 192, 194, 196, 198, 200, 202 and 204 without changing the mass either magnet 108 or spring 80.

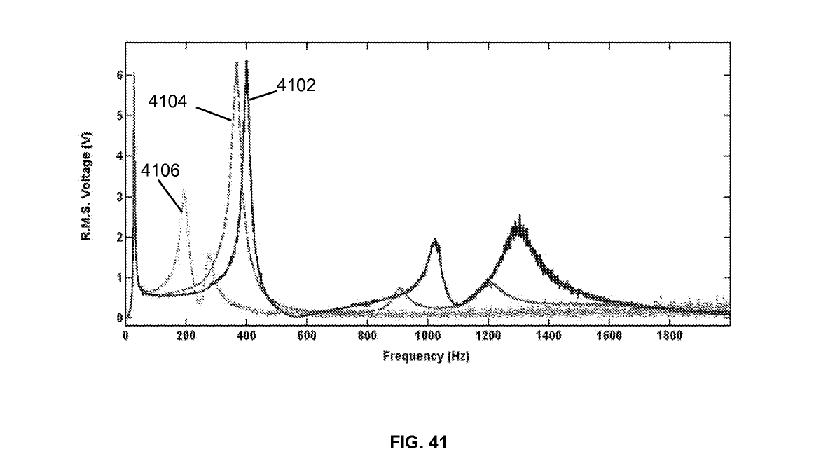

Referring to FIG. 41, a frequency response spectra or graph is shown for tuning down or tuning up of the mechanical natural resonant frequencies of energy harvester 10. In this example, energy harvester device 10 was configured with only second magnet 110 secured to second mechanical spring 82 and one (1) composite structure 180 buried in second grid 114 and second housing 32. Electrical outputs from wires 82 and 84 of one composite structure 180 were connected to a data logger. The vibrating environment was a random noise spectrum generated by a conventional shaker. Tuning was performed by tightening (stiffening) or loosening (softening) of mechanical spring 80 using clockwise or anti-clockwise turning of screw 190 by relatively small amounts. A blue line 4102 represents the output response of the piezoelectric devices to a very stiff device 10 where all the screws are tightened as tight as possible. A purple line 4104 represents the output response of the piezoelectric devices when screw 190 is loosened by very small amount (one-quarter revolution). An orange line 4106 represents the output response of the piezoelectric devices when screw 190 is loosened by more than one revolution. As shown, a series of three peaks occur for lines 4102, 4104, and 4106 at about the same frequency, namely, 29 Hz, and represent the output response of the coupled mechanical resonance with the vibration source. A second series of three peaks tuned to frequencies of about 198 Hz, 360 Hz, and 400 Hz represent the first natural resonant frequency caused by vertical translation of second magnet 110 and mechanical spring 82. A third series of peaks tuned to frequencies of about 275 Hz, 907 Hz and 1028 Hz represent natural resonant frequencies caused by a first flexure of second magnet 110 and mechanical spring 82. A fourth series of peaks tuned to frequencies of about flat (nil peak), 1204 Hz and 1302 Hz represent natural resonant frequencies caused by a second flexure of second magnet 110 and mechanical spring 82. FIG. 41 is only an example as turning of the screw by multiple revolutions shifts down the natural resonant frequency to even much lower frequencies below 120 Hz. A minimum amplification factor of 18.4 dB for the frequency range shown in FIG. 41 was obtained for tuning around the natural resonant frequencies of energy harvester 10. This represents a low total damping ratio and mechanical losses. Screws 190, 192, 194, 196, 198, 200, 202 and/or 204 of energy harvester 10 may be tightened or loosened without creating significant mechanical losses to the device.

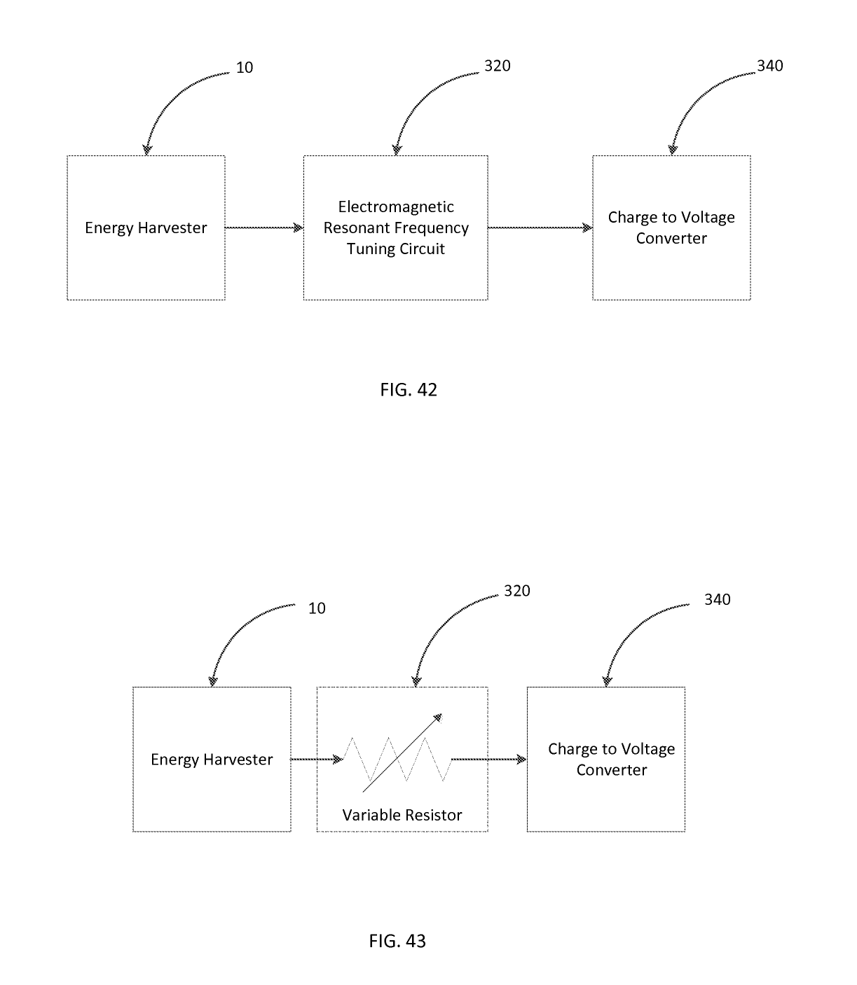

Referring to FIGS. 42 and 43, there has been little study on how to adjust or tune the electromagnetic natural resonant frequency of an energy harvester operating in an electromagnetic environment. FIG. 42 shows an electromagnetic natural resonant frequency tuning circuit 320 connected between the outputs of energy harvester device 10 and a conventional charge-to-voltage converter 340 such as those produced by DJB Instruments, Meggitts (Endevco Corporation). Tuning circuit 320 allows the electromagnetic natural resonant frequency of energy harvester 10 to be tuned electronically without changing the mechanical natural resonant frequencies of the energy harvester device 10. As shown by FIG. 43, tuning circuit 320 comprises a variable dissipative element such as a variable resistor between the outputs of energy harvester device 10 and the input of charge-to-voltage converter 340.

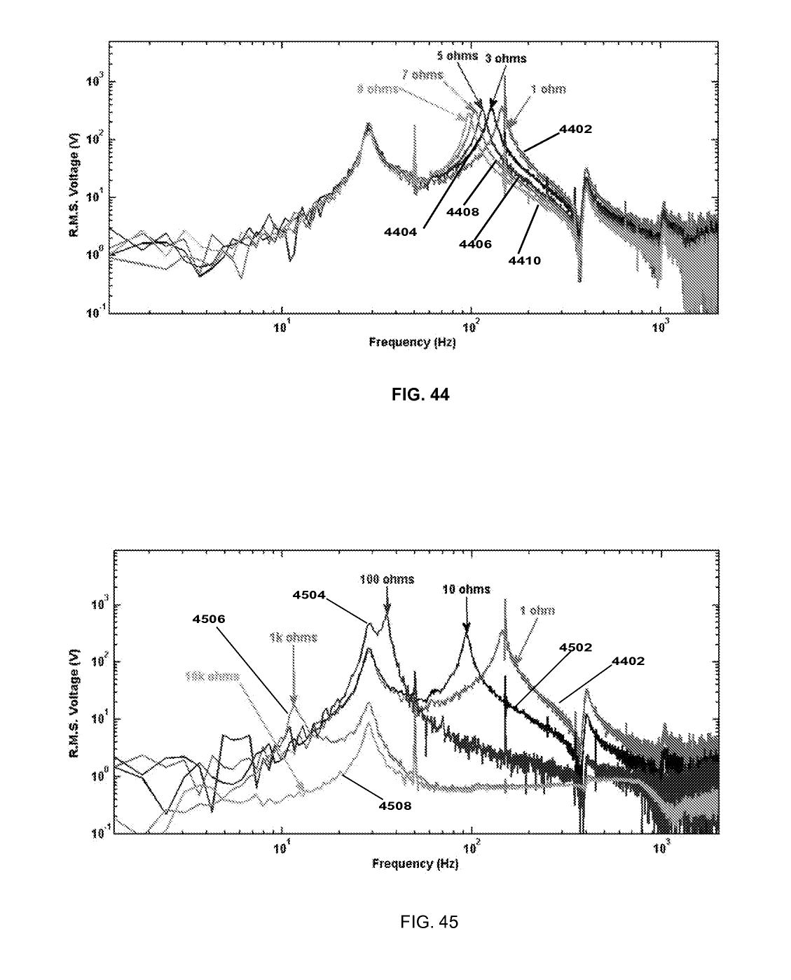

Referring to FIGS. 44 and 45, a frequency response spectra or graph is shown for tuning down or tuning up of the electromagnetic natural resonant frequency of energy harvester 10. In this example, energy harvester device 10 was configured with only second magnet 110 secured to second mechanical spring 82 and one (1) composite structure 180 buried in second grid 114 and second housing 32. Electrical outputs from wires 82 and 84 of composite structure 180 was connected to charge-to-voltage converter 340 by tuning circuit 320. The electromagnetic environment was generated by radiations from AC power cords of electrical instruments and operating machineries. Tuning was performed by changing the value of the variable resistor of tuning circuit 320. As shown in both FIGS. 44 and 45, a red line 4402 is the measured output response from charge-to-voltage converter 340 with the variable resistor of tuning circuit 320 set to 1 ohm. As shown in FIG. 44, a black line 4404 is the measured output response from charge-to-voltage converter 340 with the variable resistor of tuning circuit 320 set to 3 ohms. As shown in FIG. 44, a blue line 4406 is the measured output response from charge-to-voltage converter 340 with the variable resistor of tuning circuit 320 set to 5 ohms. As shown in FIG. 44, a pink line 4408 is the measured output response from charge-to-voltage converter 340 with the variable resistor of tuning circuit 320 set to 7 ohms. As shown in FIG. 44, a green line 4410 is the measured output response from charge-to-voltage converter 340 with the variable resistor of tuning circuit 320 set to 9 ohms. As shown in FIG. 45, a black line 4502 is the measured output response from charge-to-voltage converter 340 with the variable resistor of tuning circuit 320 set to 10 ohms. As shown in FIG. 45, a blue line 4504 is the measured output response from charge-to-voltage converter 340 with the variable resistor of tuning circuit 320 set to 100 ohms. As shown in FIG. 45, a pink line 4506 is the measured output response from charge-to-voltage converter 340 with the variable resistor of tuning circuit 320 set to 1000 ohms. As shown in FIG. 45, a green line 4508 is the measured output response from charge-to-voltage converter 340 with the variable resistor of tuning circuit 320 set to 10,000 ohms. A first peak measured at about 29 Hz represents the coupled mechanical resonance of vibration source; the second peak tuned around to different frequencies represents electromagnetic resonant frequency caused by electromagnetic waves from the environment; and the third peak remaining unchanged in frequency position at ca 400 Hz represents first natural resonant frequency caused by vertical translation of second magnet 110 and mechanical spring 82. When the EM resonant frequency is tuned down to the lower frequency region, minimum quality factor drops and flattens out to 0 dB at extremely low frequencies. As shown in the table below, the electromagnetic natural frequency of energy harvester device 10 varied from 145.26 Hz with the resistance of tuning circuit 320 set at 1 ohm to 3.66 Hz with the resistance of tuning circuit 320 set at 10,000 ohms:

| | Electromagnetic Natural |
|---|---|
| Resistance (Ohms) | Frequency |
| 1 | 145.26 |
| 3 | 127.56 |
| 5 | 114.14 |
| 7 | 104.37 |
| 9 | 96.43 |
| 10 | 93.38 |
| 100 | 35.40 |
| 1000 | 11.60 |
| 10000 | 3.66 |

The present invention allows the tuning of the electromagnetic resonance caused by electromagnetic waves that are mutually coupled to vibration frequency response of energy harvester device 10 without changing natural resonant frequencies of energy harvester device 10. Tunability is over 150%, highest performance when compared with conventional tuning methods for energy harvesting as described in background of the invention.

The above description is intended primarily for purposes of illustration. This invention may be embodied in several other forms or carried out in other ways without departing from the spirit or scope of the invention. Modifications and variations still within the spirit or scope of the invention as claimed will be readily obvious to those of skill in the art.

What is claimed:

1. A device for harvesting energy from a vibrating environment having a natural frequency, the device comprising:
a first housing;
left and right sidewalls engaged with said first housing by first and second fasteners;
a mechanical spring engaged with said left and right sidewalls;
a first magnet engaged with said mechanical spring;
a composite structure comprising a fixed magnet and a piezoelectric material; said first magnet and said fixed magnet apply a force upon said piezoelectric material when said mechanical spring is in said static state to produce a base voltage;
adjustment of said first fastener to a first position and excitation of said mechanical spring by the vibrating environment causes said piezoelectric material to generate a first alternating voltage output comprising a first peak voltage at a first frequency greater than said base voltage; said first frequency being different from the natural frequency of the vibrating environment;
adjustment of said first fastener to a second position and excitation of said mechanical spring by the vibrating environment causes said piezoelectric material to generate a second alternating voltage output comprising a second peak voltage at a second frequency greater than said base voltage; said second frequency being closer to the natural frequency of the vibrational environment than said first frequency.

2. The device of claim 1, wherein said first fastener is a screw.

3. The device of claim 2, wherein said second fastener is a screw.

4. The device of claim 3, wherein said mechanical spring is made from a thin piece of metal.

5. The device of claim 4, wherein said metal is stainless steel shim stock having a thickness of 0.20 mm.

6. The device of claim 1, further comprising an electromagnetic resonant frequency tuning circuit connected with said piezoelectric material.

7. The device of claim 6, wherein said electromagnetic resonant frequency tuning circuit comprises a variable dissipative element.

8. The device of claim 7, wherein said variable dissipative element comprises a variable electronic resistor.

9. A method for tuning the mechanical natural resonant frequency of an energy harvester for use in a vibrational environment having a natural frequency, the method comprising the steps of:
providing an energy harvester comprising a first housing, a left sidewall engaged with said first housing by a first fastener; a right sidewall engaged with said first housing by a second fastener; a mechanical spring connected between said left and right sidewalls; a first magnet attached to said mechanical spring; a composite structure comprising a fixed magnet and a piezoelectric material; said first magnet and said fixed magnet apply a force upon said piezoelectric material when said mechanical spring is in a static state to produce a base voltage;
adjusting said first fastener to a first position and excitation of said mechanical spring by the vibrating environment causes said piezoelectric material to generate a first alternating voltage output comprising a first peak voltage at a first frequency greater than said base voltage; said first frequency being different from the natural frequency of the vibrating environment;
adjusting said first fastener to a second position and excitation of said mechanical spring by the vibrating environment causes said piezoelectric material to generate a second alternating voltage output comprising a second peak voltage at a second frequency greater than said base voltage; said second frequency being closer to the natural frequency of the vibrational environment than said first frequency.

10. The method of claim 9, wherein said step of adjusting said first fastener to a second position comprises the step of loosening said first fastener to adjust the tightness of said mechanical spring to said left sidewall.

11. The method of claim 10, wherein said step of adjusting said first fastener comprises the step of tightening said first fastener to adjust the tightness of said mechanical spring to said left sidewall.

12. A method for tuning the electromagnetic resonant frequency of a vibration energy harvester used with a charge-to-voltage converter having an input without changing the mechanical natural resonant frequency of the energy harvester, the method comprising the steps of:
providing a variable dissipative element between the output of the vibration energy harvester and the input of the charge-to-voltage converter; and
changing the resistance of said variable dissipative element.

13. The method claim 12, wherein said step of changing the resistance of said variable dissipative element comprises the step of increasing the resistance of said variable dissipative element.

14. The method claim 12, wherein said step of changing the resistance of said variable dissipative element comprises the step of lowering the resistance of said variable dissipative element.

15. A system comprising:
an energy harvester comprising an output;
a charge-to-volt converter comprising an input; and
an electromagnetic resonant frequency tuning circuit comprising an input connected with said output of said energy harvester and an output connected with said input of said charge-to-volt converter.

16. The system of claim 15, wherein said energy harvester comprises:
a sidewall;
a mechanical spring engaged with said sidewall;
a first magnet engaged with said mechanical spring; and
a composite structure comprising a fixed magnet and a piezoelectric material connected with said electromagnetic resonant frequency tuning circuit.

17. The device of claim 16, wherein said electromagnetic resonant frequency tuning circuit comprises a variable dissipative element.

18. The device of claim 17, wherein said variable dissipative element comprises a variable electronic resistor.
